(19) United States
(12) Patent Application Publication
(10) Pub. No.: US 2016/0148222 A1
(43) Pub. Date: May 26, 2016

(54) Social Proof of Organizations

(71) Applicants: Ali DAVAR, Vancouver (CA); Simon James HEWITT, Vancouver (CA); David Robert THOMPSON, Vancouver (CA)

(72) Inventors: Ali DAVAR, Vancouver (CA); Simon James HEWITT, Vancouver (CA); David Robert THOMPSON, Vancouver (CA)

(73) Assignee: 0934781 B.C. LTD, Vancouver (CA)

(21) Appl. No.: 14/937,203

(22) Filed: Nov. 10, 2015

Related U.S. Application Data
(63) Continuation-in-part of application No. 14/537,092, filed on Nov. 10, 2014.
(60) Provisional application No. 62/101,952, filed on Jan. 9, 2015.

(51) Int. Cl. G06Q 30/02; G06Q 50/00

(52) U.S. Cl. CPC G06Q 30/0201; G06Q 50/01

(57) ABSTRACT

A computer method and system provide means for inputting and outputting business relationship data to a user. The system comprises a database of business relationships between organizations, which is connectable to a social network. A user may search for an organization according to search criteria and the system will select a set of organizations that match the criteria along with a set of social contacts of the user. The relevancy of the social contacts to the organization is calculated and web content is displayed showing the organizations and social contacts.

### BACKGROUND

Business typically requires a multitude of businesses to work together, wherein there are many involved in a supply chain, many acting as service providers, advisors, brokers and of course customers to pay for it all. To be successful, a business is required to identify and assemble a network appropriate to service the business at each point. In many cases an organization will have an established network; however, there is commonly a need for an organization to locate a new supplier, partner, client, or buyer. These can be easily found with reference to an Internet search engine or phone directory. Dedicated websites currently exist to provide a user with a list of businesses according to a particular industry or service/product offered.

However, this does not help the searcher determine which potential supplier/client is the best or most relevant to themselves. By human nature it is common to ask who is used and trusted by other businesses that are respected by the searcher.

This information is usually only known to those with years of experience, are well connected or who have access to specialist business directories. In some cases relationships can be determined from online or physical records but it is not always possible to know the nature, trust, strength, or present activity of the relationship. The search is typically made against some criteria such as location or sector. Even with knowledge of these relationships, it is not a simple matter to search by certain criteria, filter certain categories or weigh large amounts of such data.

Existing platforms attempt to solve this problem by creating searchable directories of businesses and/or providing reviews from other users. In some instances, the list is ranked according to a metric such as size or revenue. In these cases the user must judge what review or metric might be suitable for their own business. Most recently, classes of programs called Recommendation Systems look for similarity between users to recommend products and services.

Additionally a business may wish to publicize its relationships with other businesses. This may be accomplished using news releases, public relations firms, or listings on their websites. This may require permission of the connected company. There may be some relationships that either company to the relationship is not comfortable revealing, or at least not using their own name. In this case, there is no way for the vendor or client to demonstrate their relevance in a certain sector and a business searching for an appropriate vendor or client will not be able to determine their relevance.

Certain business directories attempt to help a user decide between the numerous businesses listed by providing a mechanism for other users to input a review of a product or service. This creates a human face to the problem but there is little chance that the user will know or have reason to trust and respect the reviewer. The publicity of the reviews also leads to suspicion that the reviewer was appeasing the business being reviewed.

### BRIEF SUMMARY OF THE INVENTION

The inventors have envisaged a database, network, system, and methods for operating with data for business evaluation. The inventors have appreciated that there may be hundreds of people socially connected to a user, some of which could provide a review if asked. A social network can be used to identify such people and a business network can be used to determine which people are relevant to a particular business.

In accordance with a first aspect of the present invention there is provided a computer-implemented method of preparing web content. The method comprises using a computer processor, selecting, from a business database recording business relationships between organizations, first organizations that are connected by a business relationship to one or more second organizations; using a computer processor, accessing a social network and receiving a set of social contacts of a user; for each first organization, associating a set of referees, the referees being social contacts that have an employment connection with at least one of the second organizations connected to that first organization; using a computer processor, selecting at least a subset of said first organizations based on their associated referees; preparing web content comprising the subset of first organizations and their associated referees; and communicating said web content to the user's computing device.

In accordance with a second aspect of the present invention there is provided a computer-implemented method of displaying web content. The method comprises using a computer processor, selecting from a business database first organizations and people associated as referees for the first organizations; using a computer processor, accessing a social network and receiving a set of social contacts of a user; for each first organization, determine which referees are also social contacts of the user; selecting at least a subset of said first organizations based on their referees that are social contacts of the user; preparing web content comprising the subset of first organizations and their referees that are social contacts of the user; and serializing and communicating said web content to the user's computing device.

In accordance with a third aspect of the present invention there is provided a computer system comprising: a database of business relationships between organizations; one or more computer processors; and computer-readable media having instructions for execution by the one or more processors. The instructions when executed provide: a data access agent for retrieving first organizations and second organizations that are connected by a business relationship; a social network agent for retrieving a set of social contacts of a user, and associating each first organization with social contacts that have an employment connection with second organizations having a business relationship with that first organization; an output agent for selecting at least a subset of said first organizations based on their associated referees and preparing web content comprising the subset of first organizations and their associated referees; and a serialization agent for communicating said web content to the user's computing device.

In accordance with a fourth aspect of the present invention there is provided a computer-implemented method for identifying referees for a first organization comprising: identifying a business segment of the first organization; identifying business segment keywords for the identified business segment; identifying a set of professional profiles and retrieving their professional experience data; for each profile, using a computer algorithm to identify keywords in the respective professional experience data and to compare these keywords to the business segment keywords to calculate each profile's professional relevancy score; ranking the profiles, using the professional relevancy scores, to identify a set of referees to the business segment of the organization; and preparing web content using at least a subset of the ranked profiles and outputting the web content to a client-computing device.

In accordance with a fifth aspect of the present invention there is provided a computer-implemented method comprising: one or more processors identifying a plurality of vendors of a service to be recommended to an identified user; the one or more processors calculating an initial score for each vendor; the one or more processors selecting and displaying a first subset of the vendors according to the initial score; the one or more processors accessing a social graph to determine a set of social contacts having social connections to both the user and to at least one employee of the plurality of vendors; selecting a set of social contacts to be referees; the one or more processors sending the referees a survey for recommending each employee with whom they have a social connection, which recommendation is made with respect to the service; the one or more processors calculating an updated score for the vendors partly based on recommendation of their employees received from the referees; and the one or more processors selecting and displaying a second subset of the vendors according to the updated score.

Further features of preferred embodiments are set out below which may be combined with each other or any of the above aspects of the invention.

The method may receive criteria over a network and query the business database using the criteria to select said first organizations based on attribute data of said first organizations or of the business relationships.

A method may use a computer processor to calculate a recommendation metric for each of the first organizations from a social score based on these referees and then select at least a subset of said first organizations according to the recommendation metric to output as web content.

A method may retrieve professional experience data from the social network for each referee and calculating the social score using a relevance of said professional experience data to the associated first organization or a business segment thereof.

A method may retrieve endorsement data from the social network for each referee and calculate the social score using a relevance of said endorsement data to the search criteria.

A method may respond to a user interaction with the web content to an interactive graphic element corresponding to a selected referee to initiate a survey request to that referee. A method may send a survey request to a selected referee. The survey request may comprise a link to a survey web page comprising interactive survey elements.

A method may retrieve survey content from a database of industry-specific survey content and providing said survey content to a selected referee. A method may receive and analyze a survey response from the selected referee and calculating the social score of an associated first organization using the analysis. The analysis may be stored in the database.

Calculating the social score for each first organization may comprise aggregating survey responses about that first organization from social contacts of the user and previous survey responses from social contacts of other users.

Calculating a recommendation metric for each of the first organizations may comprise calculating a client similarity score based on similarity between the second organizations and a third organization for whom the user works.

Calculating a recommendation metric may further comprise calculating a relevancy metric for each of the first organizations based on the relevance of their attribute data to the criteria.

Selecting at least a subset of said first organizations may comprise using each of a plurality of scoring schemes to select at least one organization.

The web content may further comprise identification data of second organizations that are marked as visible and identification data of second organizations that are marked as hidden if that second organization is an employer of one of the social contacts.

The system may provide a user-interface for receiving criteria for a recommendation of first organizations from a user.

The instructions may further provide a survey agent for communicating a survey to a social contact selected by the user.

The survey agent may be arranged to receive a response to said survey and analyze said response and store the analysis in the database.

The database may comprise organization records, relationship records and records for storing survey response data for an organization.

The business segment keywords may be words that characterize the business segment, the first organization or a potential referee.

Identifying the set of profiles may comprise retrieving social contacts that are connected in a database with the first organization or a user.

Ranking the set of profiles may comprise identifying a set of second organizations having a business relationship with the first organization and determining which profiles' professional experience data include past or current work experience with any of the second organizations.

Identifying the set of profiles may comprise identifying people in a social network recorded as Though Leaders or Opinion Leaders in an industry relevant to the business segment.

The computer algorithm may perform cluster analysis to organize the business segment keywords into clusters and compares the clusters to the keywords of each profile's professional experience data to calculate each profile's professional relevancy score

The business segment may be one or more of: the whole of the first organization, a product, a service, a specialism, and an industry.

A method may receive user-entered data about the business segment into a business relationships database and the outputted web content may provide means for the user to select one or more professional profiles to be linked to the business segment of the first organization as a referee.

The business segment of the first organization is selected according to a criteria entered by a user.

### BRIEF DESCRIPTION OF THE DRAWINGS

The invention may be illustrated by the following figures, in which like reference numerals refer to similar elements.

FIG. 1 illustrates a diagram of a network of computers for accessing a database of business relationships.

FIG. 2 is a diagram of agents for interaction between a client device and server.

FIG. 3 is a diagram of example relationships in a graph.

FIG. 4 is a diagram of example relationships in a relational database.

FIG. 5 is a display of vendor data from a search query.

FIG. 6A is a diagram of a database graph structure.

FIG. 6B is a diagram of a graph structure showing business connections relevant to a search and their weightings.

FIG. 7 is a flow diagram of data flow and connections between software agents to output a set of vendors.

FIG. 8 is a diagram of identified vendors and social connections.

FIG. 9 is a flowchart of a process for calculating various scores and soliciting surveys for vendors.

FIG. 10 is a diagram illustrating how a review is solicited for a vendor.

FIG. 11 is a diagram of a survey interface and the datasources for generating it.

FIG. 12 is a flowchart of a process to calculate a professional relevancy score.

FIG. 13 is a diagram for analyzing a social contact's relevancy as a referee.

FIG. 14 is a social graph of people relevant to a vendor survey process.

FIG. 15 is a flowchart for selecting social intermediaries.

FIG. 16 is a diagram of vendor rankings (a) before and (b) after survey responses have been received from social contacts.

### DETAILED DESCRIPTION

A system, network, and computer program are implemented to capture the relationships between organizations. This enables users as viewers to determine the relationships between organizations or search for an organization according to certain criteria. This also enables users as content creators to demonstrate their place and associations in the business community for viewers to analyze.

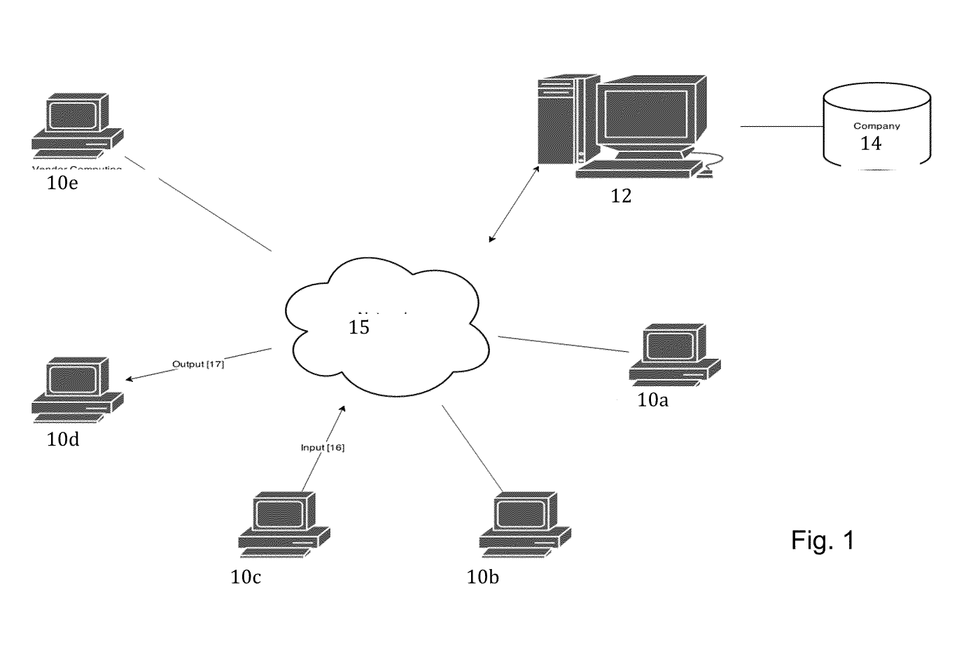

As shown in FIG. 1, the system may be implemented as a network 15 of interconnected computing devices 10a-e and server 12 for inputting and receiving relationship data from a database 14. The database may be a document store, relational database or graph database. Those skilled in the art of computer science will know how to implement such a database and will appreciate that there are other data structures that may be appropriate. The database 14 is connectable to user 10c for receiving data and user 10d for outputting data. The names of these devices are for simplicity of understanding and may be any computing device and each device may be used for a plurality of these roles.

The server 12 may comprise one or more processors for reading instructions from computer-readable storage media and executing the instructions to provide the methods and agents described below. Examples of computer readable media are non-transitory and include disc-based media such as CD-ROMs and DVDs, magnetic media such as hard drives and other forms of magnetic disk storage, semiconductor based media such as flash media, random access memory, and read only memory.

An organization is generally used herein to refer to a legal entity providing or receiving goods or services. While an organization may typically be a business, the term includes but is not limited to charities, corporations, sole proprietors, Non-Government Organizations, institutions, government departments, and partnerships. A business relationship is generally used herein to refer to commercial transactions between organizations to provide those goods or services. Preferably the relationship represents an agreement, which, for example, may subsist in a contract, a terms-of-business document or an ongoing understanding. Most preferably the business relationships stored in the database represent relationships that have been ongoing for at least three months, have a transactional value exceeding $100,000 or have at least three repeat instances of transactions. This is in contrast to personal relationships, non-commercial relationships, click-thru data or user website activity data, or one-off commercial transactions. Therefore the strength of the present recommendation is derived from a deep tie between organizations, as recorded in the database. An ongoing, high-value relationship is used as a proxy to suggest that one organization is a worthy supplier of goods or services.

A user is generally defined as a person who interacts with a computer, typically entering search criteria, following hyperlinks and viewing results to determine what organizations are recommended. The user is expected to be associated with a particular organization and is seeking a recommendation suited for that organization. In some cases, it is envisaged that there is no human user, and instead the database and methods will be accessed by a computer bot for displaying a relevant organization to an identified organization. For example, an ad-tech bot may determine using cookies or viewed content that a user is interested in a particular industry. The ad-tech bot could display one or more organizations or their ads to the user, depending on what organization is most relevant to the user's organization.

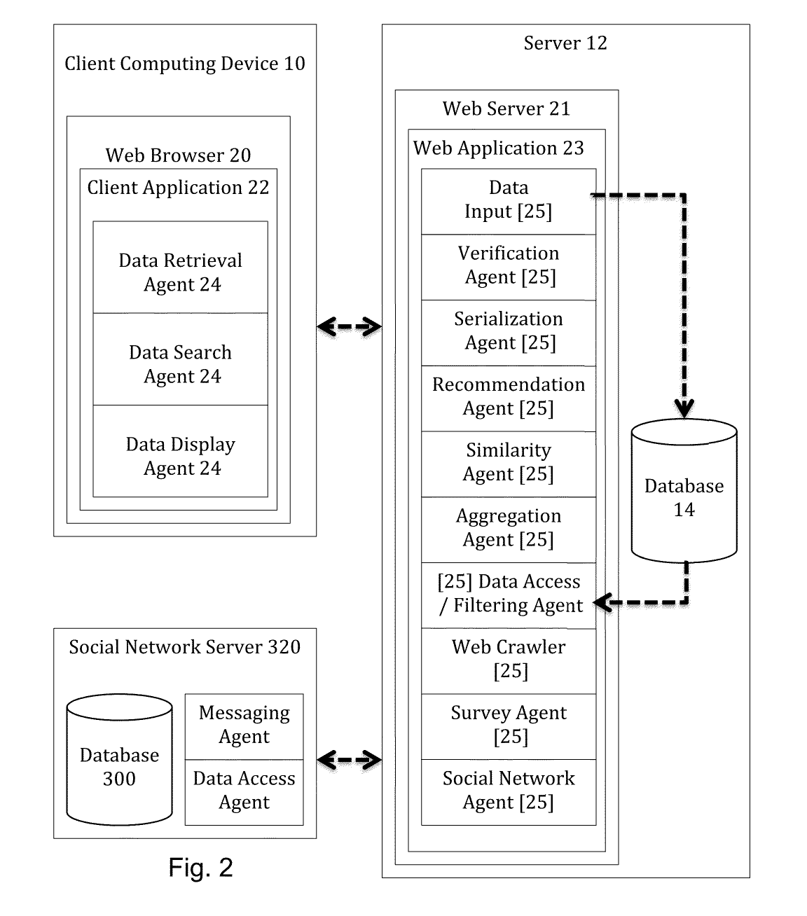

FIG. 2 illustrates the interaction between a client computation device 10 and the server 12 over network 15. The device 10 may interact via a web browser 20 having an application layer 22. The application may use software agents 24 to search the database 14, retrieve output data 17 and display the data on the user's device. The server 12 may be a reverse proxy server for an internal network, such that the client 10 communicates with an Nginx web server 21, which relays the client's request to associated server(s) and database(s) 14. Within the server(s) a web application 23 comprises agents 25 for operating with the database 14.

Users may access the database 14 remotely using a desktop or laptop computer, smartphone, tablet, or other client computing device 10 connectable to the server 12 by mobile internet, fixed wireless internet, WiFi, wide area network, broadband, telephone connection, cable modem, fibre optic network or other known and future communication technology.

The client device 10 may interact with the server using a web browser using conventional Internet protocols. The web server will use the serialization agent to convert the raw data into a format requested by the browser. Some or all of the methods for operating the database may reside on the server device. The client device 10 may have software loaded for running within the client operating system, which software is programmed to implement some of the methods. The software may be downloaded from a server associate with the provider of the database or from a third party server. Thus the implementation of the client device interface may take many forms known to those in the art. Alternatively the client device simply needs a web browser and the web server 12 may use the output data to create a formatted web page for display on the client device.

The methods and database discussed herein may be provided on a variety of computer system and are not inherently related to a particular computer apparatus, particular programming language, or particular database structure. In preferred embodiments the system is implemented on a server. The term ‘server’ as used herein refers to a system capable of storing data remotely from a user, processing data and providing access to a user across a network. The server may be a stand-alone computer, mainframe, a distributed network or part of a cloud-based server.

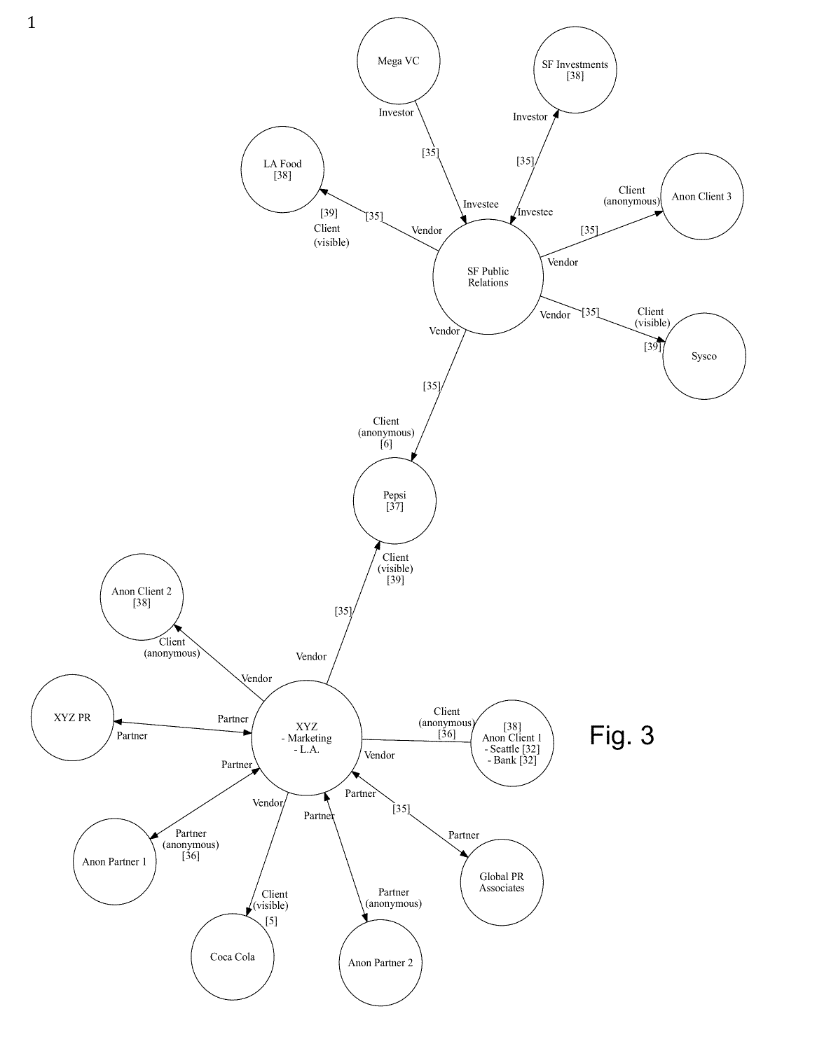

As conceptualized in FIG. 3, the database is structured to record a plurality of relationships 35 with data about the relationships such as the nature of the relationship, attributes 32 about the organizations 38, and identification data (such as a name). A code may be used in the database to indicate that a party is a visible party 39 or an anonymous party 36.

There may be only one relationship recorded for an organization but in most cases there will be many. The database preferably comprises millions of organizations and relationships.

The nature of the relationship may be displayed textually or graphically. The direction is indicated graphically in FIG. 3 using an arrow from the supplier of goods or services to the receiver.

As shown in this example, fifteen nodes 38 representing organizations are interconnected via fourteen relationships 35, indicating which organization in the relationship is a client, vendor, investor, partner, etc. When displaying ‘XYZ's’ profile, four parties will be identified and four parties will be hidden. In the case of ‘Anon Client 1’, the attribute data ‘Seattle’ and Bank may be displayed instead of the party name. As indicated, the ‘Hewitt Corp’ node is marked as visible in the relationship with ‘XYZ’ but anonymous in the relationship with ‘SF Public Relations’.

Certain existing social networks allow the user to take part whilst remaining anonymous themselves. For example, Quora™ users can ask or answer questions anonymously and LinkedIn™ users can view profiles anonymously. In the presently described system, the organization entering data will be known to other users, however, their connected organization may be anonymous.

In contrast to certain social networks, where users may assume pseudonyms and are free to enter fictional data about themselves or others, it is preferred that the present database contain only real parties, their real attributes and their actual relationships. Thus the present system provides methods for authenticating data as well as the users entering the data. In one embodiment, newly entered data is stored in a separate database not visible to viewers. In another embodiment newly entered data is stored in the main database but is marked as ‘unverified’. Immediately or at a later time, a program searches reputable records or websites to corroborate the data. The program may be a web crawler or web scraper. The website may be the official website of one of the parties to the relationship. The reputable record may be a government registry.

In contrast to other social networks storing mutual, non-directional connections (friend-friend, associate-associate, classmate-classmate), the present database and system are arranged to record the nature of relationships and their direction, for example, as indicated by the flow of goods and services from a third organization to a first organization. For example the direction may be unidirectional in the case of buyer-seller or bidirectional in the case of a partnership. This creates added complexity to the database but provides more information to viewers and creates additional search criteria.

For example, two banks may be peers to a user's organization that is looking for legal services, but the bank that receives legal advice from a law firm is more relevant than the bank that provides financial services to that law firm.

By way of example, the nature of the relationship may be described in general terms: vendor-client, provider-receiver, buyer-seller; or in specific terms: partners, client-advisor, manufacturer-assembler, designer-distributor-retailer, joint venture, client-service provider, investor-investee, parent-subsidiary.

Alternative terms will occur to the skilled person as appropriate descriptions of a business relationship.

A relationship record may include relationship attribute data giving further details such as the good and services, time frames involved, investment amount, product type, sales amount, or terms of the contract. For example, “XYZ has sold reagents to NY Biotech Ltd since 2008, on a non-exclusive basis”. This relationship attribute data provides the user with in-depth understanding of how each organization operates in the business community.

The system may be operated as a social network or online community wherein numerous users input numerous relationships between numerous companies. This allows users to share information with other users. Such sharing on social networks has been found to encourage the newly connected parties to become users themselves and input their own relationships with existing users or potential users, such that the total number of records expands exponentially.

### Database Format

The database may be implemented in a variety of ways known within computing science, such as a document store, object database, relational database or a graph database. Depending on the schema used the data about an organization may be called an object, a record or a node. Generally these may all be called a ‘data collection’ to capture the concept of a group of data elements associated with an organization without reference to a specific data schema.

In preferred embodiments, a graph database is used, wherein organizations are stored as nodes and business relationships are stored as edges. This is illustrated in FIGS. 3 by solid lines between organization circles with arrows to indicate the direction of the flow of goods or services from a vendor to a client.

The graph may comprise a second type of edge (similarity edge), which records the degree to which one organization is similar to another. The similarity edge may be non-directional or bidirectional to indicate that two organizations are mutual peers or the peer edge may be unidirectional to indicate that one organization is considered a peer of another organization but not vice versa, or at least not in the same way or degree. There may be more than one similarity edge between organizations to capture the different degrees or ways that two organizations are similarity.

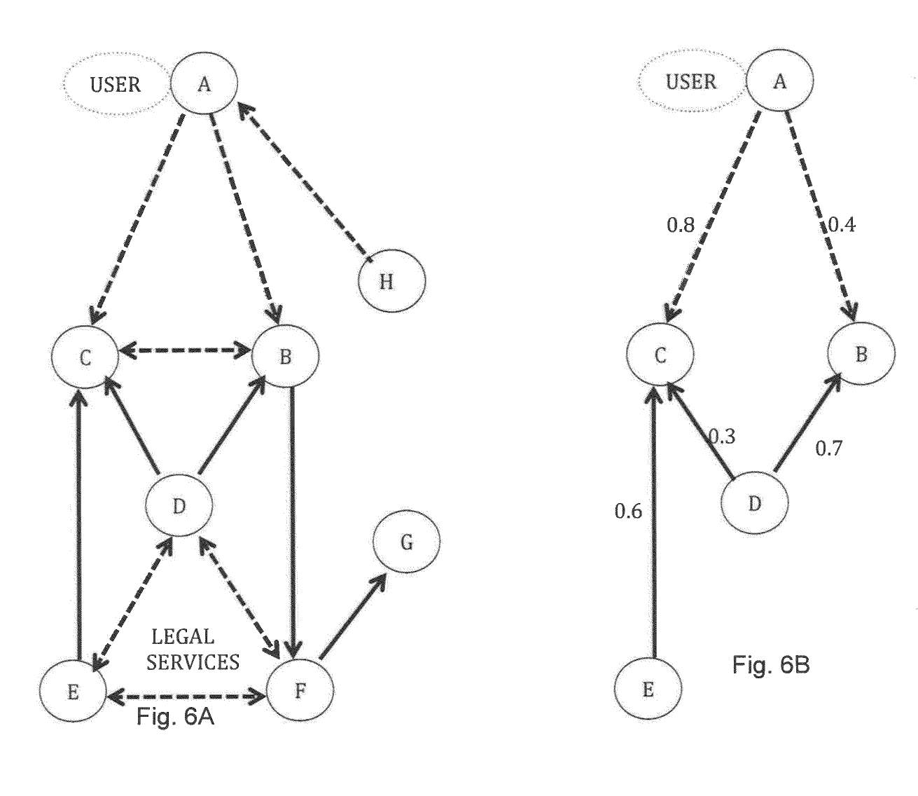

FIG. 6 illustrates a small portion of an example graph, focusing on the nodes and edges between a user's organization node (A) and vendor nodes (D, E, F) being sought. USER is associated with organization A. Solid arrows indicate relationship edges as the flow of services from a vendor node towards a client node. Dashed arrows indicate similarity edges from one organization towards an organization recorded as similar. Thus D, E and F are mutual peers and are, in this case, the target of the search. Nodes C and B are similar and both are similar to A. Node and edge values are shown separately in FIG. 6B.

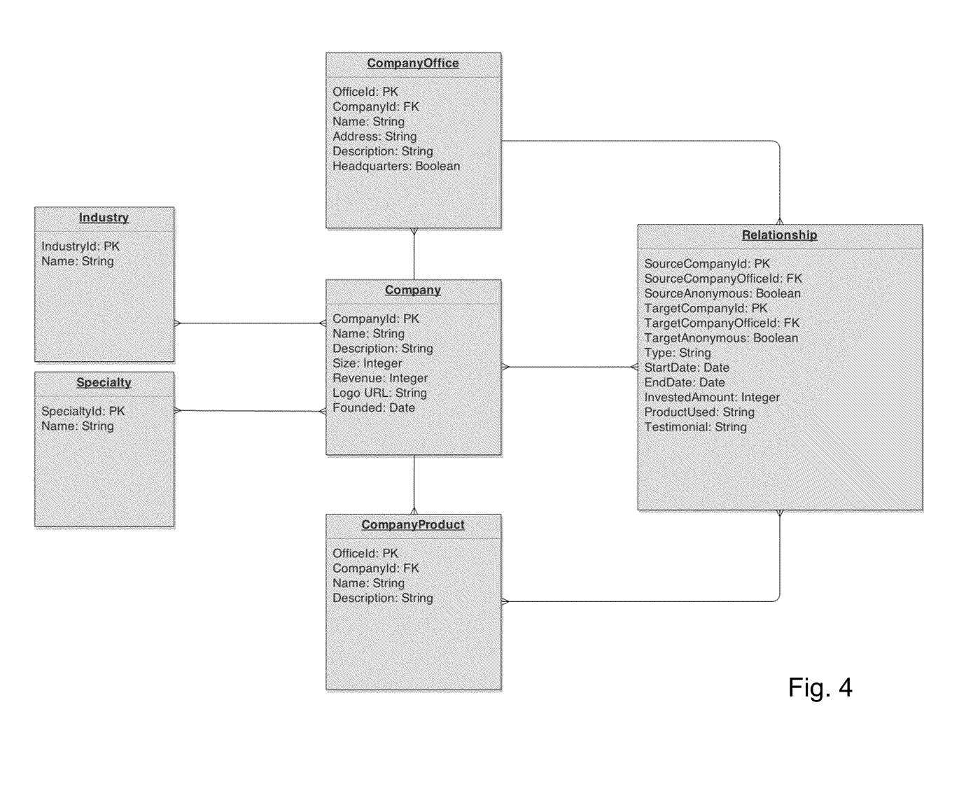

FIG. 4 shows a database arranged as a number of tables such as a table of relationship records, a table of companies, a table of industries, a table of company products, a table of specialties, and a table of company offices. Other tables may be added providing additional information linkable to the other tables. The tables may contain references to other tables for the purpose of building a complete relationship or profile, without having to replicate all data in every relationship.

For example, a relationship record comprises references to each organization and data about the relationship, including whether either organization is recorded as anonymous for that relationship. An organization's identification data may be stored in the organization record, being visible for one relationship but hidden for another.

Data about the source and target companies are stored in another table and further attributes may be stored in further tables linked to records in the company table.

Thus a complete relationship can be determined by collating data from relationship records, associated company records and associated attribute records.

In one embodiment, a relationship is assembled for output by searching the relationship table for a value (e.g. company name or relationship attribute) in one or more fields. When a matching relationship record is found, a third organization code is used to locate that organization in the company table, and a first organization code is used to locate that organization in the company table.

FIG. 4 illustrates an example relational data scheme showing the connections between tables, fields of each record in each table and data type for each field. The complete relationship to output is an assembly of data from the connected records.

In this example, there are additional tables storing data about industries (e.g. banking, manufacturing, food), specialties (investment banking, injection moulding, weddings) and products (e.g. stock transaction, toys, cakes). Such tables store data such as names of each industry and hierarchies between them.

In an alternative data scheme, complete relationships are stored as a table where each relationship record comprises fields for the third and first organization, the nature of the relationship and attribute data for each organization. This allows a relationship to be contained in a single record without the need for pointers to other tables but does require redundant storing of organization attribute data for each record.

### Data Source

The system's data input agent provide one or more ways to input a business relationship to the database, such as a website form, receiving a data file, an API callable by third-party software, and a web crawler. Preferably the relationship is input by a user working on behalf of one of the organizations (asserting organization) and comprises details about the relationship and the other organization (unverified organization). In one embodiment, a web crawler scours the webpages of organizations and/or news websites to find relationships between organizations, in which case both organizations are unverified.

In a preferred embodiment, a user inputs the relationship data. The user registers and account with the present system on behalf of their organization. The user's email domain, LinkedIn™ account, or Customer Relationship Management software can be used to authenticate the association of the user with the organization.

Additionally, the input agent provides means for the user to indicate which people would be good ‘referees’ of the organization inputting the relationship. These referees may be Thought Leaders/Opinion Leaders/LinkedIn Influencers that could provide an informed opinion about the organization inputting the relationship, and/or its products or services. Preferably the referees are current or past employees of an organization being connected to the user's organization. For example, a user employed by a vendor indicates which of the people on their social network account could act as referees for the vendor. Preferably, a plurality of employees of an organization log in using their social network accounts to identify a plurality of referees for each relationship. This ensures that the people that are shown to a searcher at a later time actually know the organization, as some organizations may be so large that not all their employees are useful referees. This act of indicating referees also helps the user increase their social network.

Some referees may be useful for vouching for the whole organization, part thereof or for a certain relationship and the scope of their vouching may be recorded. These referees are stored in the database 14, preferably connected to the organization or to the relevant relationship for future use.

The input agent may analyze a social network to determine who was employed by each organization at the same time as the asserted relationship existed and suggest a set of names for the user to approve as referees. The approved set of referees is preferably stored with the relationship record. The referees may also form the basis of contacts points to verify the relationship, as discussed below.

The system stores data for organizations in the database and can find or compare organizations depending on the nature of the data. The data may be conceptually divided into different categories:

Identification data that enable the system to identify the organization. Identification data includes data such as legal name, parent company name, CEO's name, office address, IP address, logos, brand names, or company registration number;

Profile information about the organization history, expertise, and accomplishments, possibly in an unstructured text format;

Attribute data that describe properties of the organization using categories or values, but do not identify the organization. The attribute data may be sorted and classified according to a structure with defined terms. Attribute data includes classes and values such as industry, sector, general location, specialization, product class, service class, number of employees, market capitalization, field of practice, or revenue; and

Business segment data is a subset of attribute data for describing the business function or division of an organization and includes classes such as industry, sector, specialization, product class, service class, or field of practice. Organization may be search for, categorized by, or compared within a particular business segment.

### Similarity

The personalization of the recommendation is partly based on determining what organizations are connected in a relevant way to peers of a user's organization. It is possible that some peers to one organization are not peers to all other members of that peer group or they may have additional peers not in that peer group. An organization that provides two distinct services will have two sets of peers, whereby members of each set may not consider the other set to be in their own peer group. Alternatively a similarity metric may be calculated between every organization in the database. This is computationally expensive and so this calculation is preferably processed offline and stored in the database. Preferably the processor only records similarity edges that are greater than a threshold similarity, so as to reduce the need to store data for minimally similar organizations.

In some cases, the user's organization will not have been recorded in the database with similarity edges to any known peers. In this case, similar or peer organizations are determined in real-time with the recommendation. Rather than calculate peer values for all organizations with the user's organization, it is computationally more efficient to determine a set of organizations (clients) that receive goods or services from organizations (vendors) that are relevant to the search criteria and then calculate a similarity or peer score between each selected client and the user's organization.

A similarity edge may comprise a value measuring the degree of similarity or relevance. Alternatively or additionally, similarity edges may be recorded as either TRUE or FALSE. The similarity edge may comprise a text or code indicating the nature of the similarity (e.g. “small biotech peers”, “large banks”, “subsidiaries of XYZ Corp”). The nature of the similarity may be output to a user to indicate how organizations are similar.

In preferred embodiments, similarity between two organizations is calculated using multiple algorithms, which consider different factors such as attribute data and co-occurrence in media. The scores from these algorithms are weighted and combined to reach a similarity value.

As used herein, the terms ‘similar’ and ‘peers’ are related. Organizations may be considered similar because they have many attributes in common. Peers are similar with the added provision that they are in the same or related business segment (e.g. industry/sector/specialism and/or offer related products or services). Thus two organizations that have similar attribute data for size, location, and age may be considered similar but may not be considered peers if they are defined by non-similar business segment data. Organizations in the same business segment may be considered peers, and comparing other attribute data, such as revenue, location, and specialism, can further refine the peer score. The skilled person will appreciate there are many known algorithms to calculate similarity metrics and/or perform peer clustering using attributes. For example, similarity metrics could be based on Jaccard similarity coefficients or cosine distance, and peers could be clustered using expectation maximization, hierarchical clustering or density-based clustering algorithms.

Alternatively or additionally, similarity can be determined by co-occurrence in journals and social media. This can be done by searching for names of two organizations or their products appearing in the same individual blog, microblog or industry journal article. Co-occurrence can also be found by noting the frequency with which people view both organizations in a session. The co-occurrence approach is inherently less quantifiable but has the advantage of crowdsourcing to determine which organizations are actually perceived as peers or similar.

Similarity between organizations may also be inferred from an analysis of social networks and social media by determining which employees of organizations are connected. This assumes that people that share similar interests or know each other work for similar organizations. This assumption is truer for social contacts within professional networks and industry-specific media, particularly when several employees of one organization are connected to several employees of another organization. The similarity agent employs bots to determine a connectedness score between organizations based on social inter-connectivity of their employees. The similarity agent may further determine the industries of the organizations. The agent assigns this connectedness score to similarity if the organizations are in similar industries or assigns it to the verification score if the organizations are in different industries.

### Classification

An organization may be described according to an infinite array of properties, using a huge variety of terms, many of which are synonymous. In order to group together similar companies and tabulate attribute data by attribute values it is useful to use consistent, defined terms or ranges for the attribute values. Company A may be a baker located in San Jose and have 8 employees. Company B may be a café in San Francisco and have 5 employees. Both may be classified as companies in the retail food and drink sector, located in the San Francisco Bay Area with less than ten employees. This significantly reduces later processing times because there are now a limited number of attribute values to compare.

The database preferably comprises an attribute data structure having a limited number of classes and, for each class, a limited number of standard values. Example classes would be city or number of employees. Example values for these classes would be Boston/London/Madrid or 5-10/100-500, respectively. A classifier agent comprises means to classify data about an organization into a plurality of classes and store them in the database. For example the classifier may be a Decision Tree, Random Decision Forests, or Naïve Bayesian Classifiers available from machine learning tools such as SciKit Learn or Weka. For each standard term there is a vocabulary of synonyms. The classifier parses through an organization's profile data or scrapes the organization's webpage or other records for phrases and terms that are likely to be descriptive of the organization. These phrases and terms are compared to the vocabularies to determine the most suitable attribute value. The attributes are stored in the database for that organization. Tools such as WordNet or algorithms based on co-occurrence statistics enable an algorithm to automate such synonym discovery to classify terms.

The system may employ a search engine, which uses the vocabulary lists to hash a user's free-text search string to the equivalent standard term for an attribute value. For example, a search for ‘a patisserie in the Bay’ would lead to ‘patisserie’ being matched to the standard term ‘baker’, whilst the term ‘Bay’ is matched to more than one location. The method would return all organizations having the attribute ‘Baker’ with locations associated with San Francisco Bay, Bay of Fundy, Bay of Biscay, etc.

Many classes and ranges may have one or more parent values or ranges, such as the NAICS system used to classify industry. For example, a winery could be classed in the Food and Beverage sector, the Beverage subsector, Alcoholic Beverages group, or the Wine Manufacturing subgroup. Moreover many companies may have attribute data in more than one class, such as the largest blue chip companies that serve many sectors, have products in different classes, and have subsidiary companies with very different employee counts. The database is preferably arranged to store sufficient attribute data to describe the organizations and the system comprises software agents to classify and compare organizations across a plurality of attributes and levels.

### Recommendation Engine

A request to view data from the database may take the form of a search string or clicking on a hyperlink or filter button for an attribute or name. The request may come indirectly via a third party link or from search results. A request to view data about a particular organization may be answered by returning an organization's profile webpage. The present organization recommendation engine accepts such requests at the webserver and returns a set of matching and recommended organizations with context that is offered as relevant to the user's organization

The recommendation engine is a system comprising a database, processors, and software to provide a personalized recommendation of an organization for another organization. For simplicity, in the discussion hereafter, the entity for which a recommendation is sought shall be referred to as the user's organization (aka third organization), the organizations being sought shall be referred to as vendors (aka first organizations), and organizations receiving goods or services form the vendors shall be referred to as clients (aka second organizations). This supposes that a user wants to know from what vendors he should buy goods or services based on what clients use that vendor and are similar to the user. It will be appreciated that the search is not always directed at finding a vendor and that the organizations connected to a vendor are not always clients in the relationship. It will also be appreciated that the system will be used by an employee, automated search tools or a broker to search on behalf of the third organization.

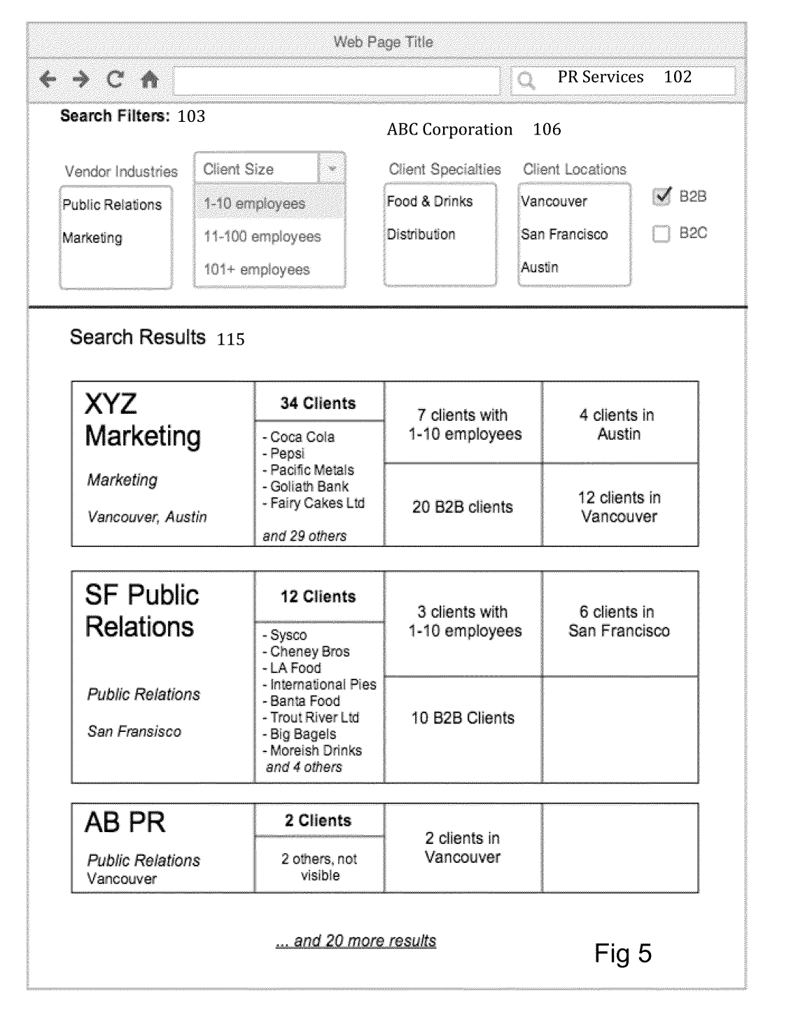

As illustrated in FIG. 5, a user interfaces with the recommendation engine and provides identification or attribute data about the searching organization 106, criteria about the organization being sought 102 and any filter criteria 103 that they wish the engine to consider. The output is a data set of recommendations 115, optionally including a score or ranking for each organization.

Using keywords or selecting interactive UI objects, the user indicates one or more criteria for the search of first organizations. Preferably the criteria are directed to business segment data. Examples of business segment data for a law firm include: law firm; lawyers; specializing in contact negotiation; and legal services. Whereas size, revenue, and location are examples of attribute data that would not indicate the type of an organization, but they could be used as criteria to refine the search, either as an input with the business segment criteria or selected during a subsequent step. The engine retrieves a set of data collections of first organizations from the database that match the criteria.

In order to personalize the recommendation of first organizations, the engine determines or receives identification data for the third organization or at least some attribute data for the third organization. In one embodiment, the engine receives data identifying the user's organization such as name, web domain, email address, IP address, or company registration number, etc. Preferably a user logs into a web portal accessing the recommendation engine with a company name or company email address. Alternatively identification may be determined by looking up the owner of the IP address of the user. Identification data can be used to determine attributes of the third organization, either with reference to the database or by scraping data from the Internet in real-time. Attribute data is used in similarity algorithms as discussed above. The identity data, if available, is further used to calculate similarity based on co-occurrence of organization names in media.

Users who wish to remain anonymous or wish not to log in may still receive a personalized recommendation by describing their organization. The description preferably includes attribute data, preferably business segment data, which could be entered as text or through menus on the interface. Example descriptions include: small business, London, $40 m revenue, hotel management, conference services.

The recommendation engine retrieves a set of data collections of second organizations from the database that are similar to the user's organization or have a relevant relationship with one of the first organizations that is relevant to the criteria.

For the purpose of the recommendation, the database can now be seen as reduced to comprising a set of data collections of first organizations, a set data collections of second organizations, and relationship data between first and second organizations. The engine may create the recommendations from the sets in at least two ways.

In a first embodiment, the engine determines all the organizations in the database that are peers of or similar to the user's organization. The engine then finds relationships in the database for each similar organization and creates a set of potential vendor organizations. The engine determines whether each of these organizations matches the business segment being sought to create a set of first organizations.

In another embodiment, the engine determines which organizations in the database match the business segment being sought to create set of vendors (first organizations). The engine then finds all relationships in the database for each vendor to create a set of clients. The engine may use the relationship direction attribute stored in the database to ignore connected organizations that are not actually clients to each vendor or use this knowledge to weight their relevance. Thus for recommending a vendor, the suppliers to that vendor are ignored or lowly weighted compared to clients of that vendor. The engine then determines which clients are peers of or similar to the user's organization to create a set of second organizations.

Potentially the sets may be very large for crowded industries with many recorded connections. Through a web interface, the user may be offered a selection of filter criteria for each set (clients and vendors) to exclude or limit the set of output vendors. For example the engine may exclude certain clients under a certain size or limit the output to vendors at certain locations. The user may also be able to filter on the names of vendors or client. Thus the Engine provides means of filtering the output vendor set based on attribute data and identity data of clients and/or vendors. Filtering may be performed at any stage. For example, having received 500 vendors, each with 100 clients, a user may choose to limit the displayed data to vendors with more than a threshold revenue amount, located in New York, and whose role in the relationships is as supplier of cosmetics.

The set of vendors may be output as an unordered set of all vendors suited for the user. To provide a more personalized view to the user, the engine preferable processes the vendor set according to a metric, such that a subset of vendors is output corresponding to the most relevant or highest scoring vendors.

In one embodiment, the engine uses the metric to determine whether each vendor is more or less suitable than another to output an ordered set of vendors.

In another embodiment, the engine computes the metric as a score for each vendor and outputs the vendors according to the scoring and optionally outputs the score itself.

It is also possible to combine the above methods. For example the engine may calculate a rough score to order the vendors, then perform direct comparisons between close scoring vendors, and then limit the output to only the top ten vendors.

The personalized recommendation metric may be calculated as a vector distance using attributes of third, first and second organizations to determine the first organizations closest to the third organization. The metric may also be calculated as a sum of weighted relationships or similarities to determine the highest score for each first organization.

The engine may calculate the recommendation metric for each vendor based on the sum of similarity values between the user and each client of that vendor. The engine may compare attribute data of these organizations as discusses elsewhere. The recommendation metric may be amended by multiplying each similarity value by a relationship value, which indicates the strength of the relationship between first and second organizations. The similarity and relationships values are preferably stored as attributes of the respective edges in the database. These values may be TRUE/FALSE but preferably are weighted to indicate more or less similarity or relationship strength.

The engine may amend the recommendation metric by calculating a relevancy metric based on the relevance of attributes of first organizations to the criteria for the recommendation. Preferably this calculates the relevance metric based on the business segment of the vendor and the type of organization sought. For example a shipping company is considered more relevant to the criteria of “shipping services” than a law firm that provides legal service to the shipping industry. The reverse recommendation would be made if the criteria were, “services to the shipping industry”. Therefore a search term may be contextualized and hashed to an appropriate organization descriptor, which is then compared to the appropriate attribute data stored with the vendor or relationship.

Returning to FIG. 6, a search for legal services (matched by nodes D, E, F) yields the reduced graph representation of FIG. 6B (where only nodes D, E indicate services provided to peers). This shows the core recommendation data needed to provide a personalized recommendation to organization A, where only peer edges from A to peers (B, C) and relationship edges from matching vendors (D, E) to client nodes (B, C) are considered. The weights of the edges are shown here for calculations below.

The result in FIG. 6B may be derived by starting from all matching vendor nodes (D, E, F), following all outward relationship edges to determine their client nodes (G, B, C), and then following all inbound peer edges from those client nodes to determine the peers (B, C) of A, for whom the recommendation is intended. Alternatively results may be derived by starting from A and following all outbound peer edges to find peer nodes (B, C) and then follow all inbound relationship edges from those peers to find matching vendor nodes (D, E).

A personalized recommendation for organization A is made by calculating a metric for each vendor as the sum of the weighted paths from A to D and E, whereby:

Score D=0.3×0.8+0.7×0.4=0.52 and Score E=0.6×0.8=0.48

The skilled person will appreciate that alternative algorithms and weightings may be used to calculate a metric for each vendor within the spirit of the invention and the invention is not intended to be limited to any particular algorithm.

Optionally the recommendation engine may supplement the personalized recommendation by including vendor nodes that do not have paths to peers of the user's organization. In FIG. 6, vendor F is does not supply services to a peer of A, notwithstanding that it receives services from a peer of A, and so does not score on the personalized system. However, it could nonetheless be output to the user as a vendor matching the search criteria, but with a lower rank than vendors D and E.

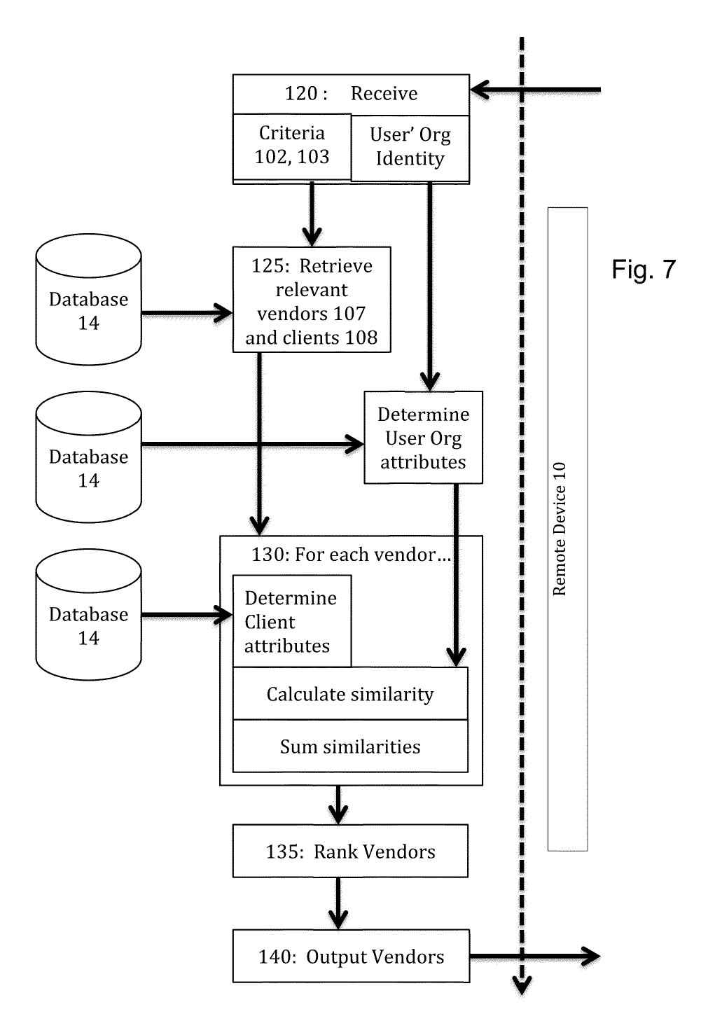

FIG. 7 is a flow diagram showing the flow of data and connections between software agents according to one embodiment. This searches for vendors then peers but the skilled person will appreciate that the agents may be re-ordered to determine peers of the user's organization before vendors.

In FIG. 7, a remote device 10 makes a query based on criteria 102, 103 on behalf of an organization (shown as the user's org here). The criteria data is sent to a receiving agent 120 to find vendors from the database 14 that match the criteria. The database returns data about matching vendors 107, their clients 108 and the relationships between them. The identification data is sent to an attribute agent to find the attributes of the user's organization from the database.

For each vendor, the recommendation metric agent 130 calculates the sum of similarities between attributes of clients and the user's organization. A ranking agent 135 then compares the metrics for each vendor to determine an order to the vendors for the purpose of this user's organization. The output agent 140 determines how many of the vendors to output and what data, such as aggregated client attribute data and vendor attribute data, should accompany each vendor. The output data is sent to the device requesting the recommendation.

### Displaying Data

In an example illustrated in FIG. 5, a webpage is displayed in response to the search query for PR services and certain filter criteria. The webpage displays the results in free text, graphics and the aggregated attribute values of its clients. The webpage displays that ‘XYZ’ supplies 34 clients, wherein twelve are located in Vancouver and four are located in Austin (and therefore some locations are undisclosed). Certain named clients are identified.

The user interface may enable the user to search by keywords and attribute filters to identify the most relevant criteria. Preferably the filters relate to divisions within each attribute to simplify and group the options for searching. As shown, the user can filter on specialty, location, industry and size. Alternatively or additionally, for each first organization, the aggregated attribute data is displayed as a natural language statement about the second organizations to provide a user-friendly output.

In this example, three companies are highlighted with details. A summarized profile of each organization is provided with hyperlinks to each organization's main profile page.

In some cases not all of the matching records will be selected. For example, the program may select the first 50 relationship records for a particular organization or select only those relationships for a searched organization which are deemed significant, in terms of value or quantity or appear more relevant to the user's organization.

Certain quantifiable attribute data may be aggregated and displayed as graphs and charts. For example, for each first organization the total number of connected second organizations in each sector or location could be tallied and displayed. This allows a viewer to make a meaningful interpretation of the huge number of relationships, even when some of the organizations are hidden. Whilst the name of a connected organization may provide a specific example, in many cases it is sufficient to understand an organization's business by evaluating how many connected organizations are in a certain sector or location, or have a certain revenue or size. The aggregation agent determines the count of third parties with attributes matching each attribute value.

Different attribute values may be selected depending on which attribute values have the highest aggregated count for each first organization or depending on the attribute value's relevance to the user's organization. For example, a vendor may have ten clients with the value ‘bank’, five clients with the value ‘baker’, twenty clients with the value ‘Boston’ and two clients with the value ‘London’. If the location attribute class is less important to the user, it may be ignored or the location value with the highest count (Boston) may be output. If the industry attribute class is very important, then the value that is most similar to the third organization is selected and output. Thus for each vendor (first organization), one or more attribute values are selected based on the relevance of the attribute class and attribute value to the user's organization, and their aggregated count is displayed.

The aggregation agent may also aggregate the relationship attributes data for each vendor. The output agent can select the highest count or most relevant relationship attribute value to display. For example, the system can display which firm has the most clients receiving particularly relevant service type.

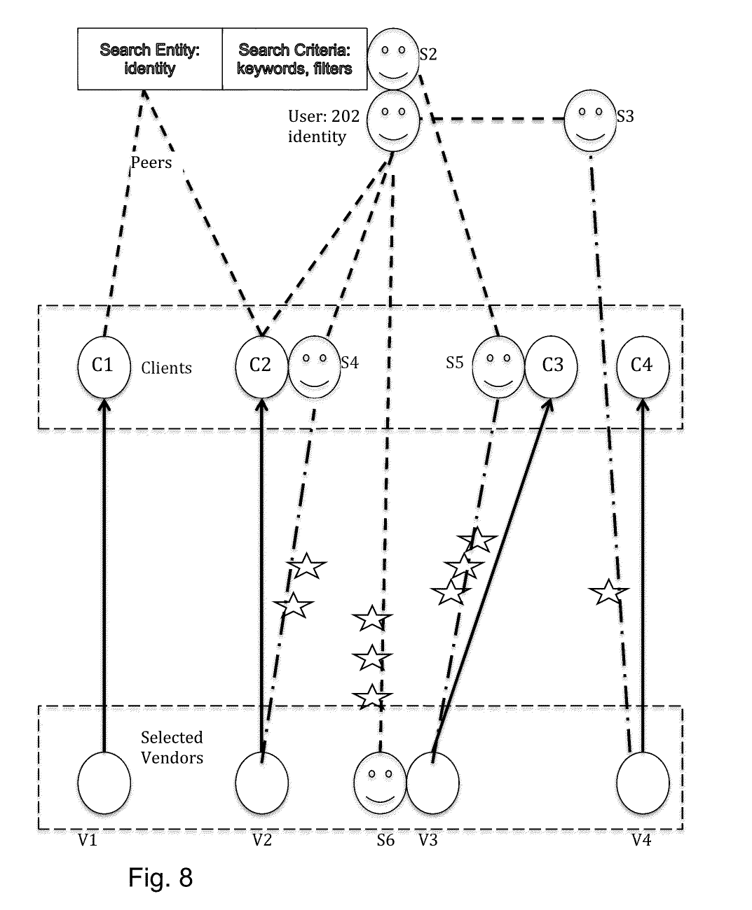

The method may not output all data for all first organizations of all relationships selected. The method may limit the output to a predetermined number of identified organizations and/or attribute values or choose which organizations or attribute values to output. This is useful in reducing the data stream to be transmitted or displayed on a screen to a manageable amount. For example, the connections for a large company may involve thousands of relationships and organizations so the program may choose to output only certain connected organizations and certain attributes values that are most numerous or deemed most relevant. FIG. 8 illustrates that in addition to the three displayed companies, 20 more results exist (that are not displayed).

A serialization agent serializes the web content in a format readable by the user's web browser and communicates said web content, over a network, to the client-computing device making the initial request.

### Social Networking

The recommendation engine is able to provide further personalized recommendation by considering the social contacts of the user. Social contacts may be found from reciprocated links in social networking sites such as LinkedIn™, Viadeo™, Facebook™, and Google+™ as well as unilateral connections such as ‘Following’ on Twitter™ and associations with affinity groups made via social media. These social contacts can serve as a referee and put a human face to the recommendation to help the user decide on a suitable organization. As used herein, a referee is a person that is contactable by a user in order to vouch, review or answer questions about an organization.

Preferably a user is associated with the third organization, typically as an employee, consultant or advisor. The social contacts are preferably associated with another organization (preferably one of the first or second organizations), typically as employees, consultants, or advisors. These employment connections may be current or past and may be determined from professional social networks. The social contacts may also be Thought Leaders/Opinion Leaders/LinkedIn™ Influencers or persons well regarded by the user, but not necessarily as employees of third, first or second organizations.

In order to gain social insight, a user preferably logs into a website to access the recommendation engine and establishes their association with an organization. For example the user may log in to the recommendation website using a LinkedIn™ account to grant the website permission to access data about their jobs and social contacts. Through social websites, it is also possible for a person to Follow or link to a company, which may establish that the user is interested in that company and would be influenced by organizations with whom they have a business relationship.

Using search criteria and the user's identity, the engine is able to output not only a set of matching first organizations but also social contacts that would potentially endorse them. An algorithm calculates a Social Score for each first organization using associations to a user's social contacts. The Social Score is used to calculate the overall Recommendation Score and ranking.

FIG. 8 illustrates a social and business graph of relationships. A review of a vendor by a social contact may be recorded in the database with any review details, such as a star rating as shown here.

Vendors matching the search criteria are determined. Their clients may also be determined, as discussed above. In this example, user 202 is shown that a friend S4 works at Client C2 who uses Vendor V2. The user also Follows Client C2 on Twitter™. The user has a coworker S2 that is socially connected to S5 who works at C3, a client of V3. The user also follows an Influencer S3 on LinkedIn™ who has endorsed Vendor V4 (with one star) in several relevant trade journals. The user may also be a member of a professional body or subscribe to a trade journal that has awarded a particular vendor, making this award more relevant than other awards. The user is socially connected to S6, an employee of V3, and endorses them (with three stars), which is an indirect endorsement of his employer. In these ways, the system is able to associate a user's social contacts with vendors.

Whilst human nature may disincline a user to give weight to referees that are more than one social or business connection away from the sought organization, certain embodiments envisage that even indirect connections will be output to the user. One particularly useful example is where one of the intermediary connections is a coworker of a user, in the case of social contacts, or a subsidiary, in the case of business connections. The engine determines from the databases of social contacts and businesses relationships whether there is an exceptional connection and informs the user that his coworker would know someone at a vendor or that a vendor is already used by an associated business within the user's corporate organization. The engine could output this information to enable the user to make a decision based on a wider consideration.

To further establish the degree of strength between social contacts, the engine further determines whether there is an endorsement recorded between social contacts, preferably determining whether one person has recorded a ‘recommendation’ for the other person. It is common for users of social networks to garner large numbers of friends, followers, and professional associates to widen the user's influence, without necessarily respecting their opinions. Some social networks additionally record whether a user has ‘endorsed’ his social contact, perhaps for a particular skill, which skill might be relevant to the vendor recommendation. In LinkedIn™ these extra ties are recorded as endorsements; in Facebook™ these ties could be recorded as people in a private group; and in Google+ these could be found from ‘Circles’ corresponding to colleagues. In certain embodiments, the engine determines whether a user has endorsed an employee of a second organization that is connected to a first organization, which gives this social contact extra weight, particularly if the endorsement is relevant to evaluating the first organization. In another embodiment, the engine determines whether a user or social contact endorses an employee of a Vendor. The implication is that people trusted or respected by a user are more relevant to the Vendor selection process.

It will be appreciated that, using social contacts, an organization that has no relevant business connections recorded on the database can still be recommended to a user. It is thus possible in certain embodiments to allow the user to find an organization without identifying his own organization. The recommendation engine may use the set of social contacts in calculating the recommendation metric for first organizations.

As social networks grow, there increasingly arises the possibility of proffering to users, social contacts that have any small connection to what is being searched. This can lead to frustration when the social contact is in fact of no help in the recommendation because they have no experience or their opinions would be immaterial. In one embodiment, the social contacts' professional experience data (e.g. job title, education, professional groups, seniority, skills, professional certification/designation, years of experience, or a summary of experiences) are retrieved from the social network. The engine uses this data to calculate the Social Score of a first organization (vendor) using a weighted count of social contacts, whereby the weight depends on a Professional Relevance Score using the professional experience data. The Professional Relevance Score is a measure of the relevance of the social contact to the business segment of the organization being evaluated. A business segment may be the whole of an organization or its industry, specialism, product or service. The business segment to evaluate may be selected using the search criteria. As discussed above, business segments are a type of attribute data, a plurality of which may be recorded for an organization.

Alternatively the engine may simply return a Boolean value indicating whether the social contact is relevant and counts towards the Social Score. For example the engine may determine whether at least a threshold number of words or fields indicate the social contact is relevant.

Each field in the professional experience data may be weighted differently, e.g. job titles may be weighted more than social groups. In each field, keywords are determined and compared to a set of words that are relevant to the business segment. Certain attributes about the keywords, such as “Senior”, “Director”, “Expert” as well as the number of years of experience, may additionally be used to weight the significance of the keyword. Alternatively the engine may use a less structures approach and search for keywords anywhere in the profile. Using a structured or unstructured approach, the keywords and attributes are extracted and compared to keywords that are relevant to the business segment.

For example, a user may be shown five social contacts associated with one vendor, wherein only two contacts have job titles that appear relevant to judging the vendor, such that the vendor's Social Score is 2.6 (1.0 points per relevant person and 0.2 per less relevant person).

The relevance of the social contact may be multiplied by the strength of any review they provide to calculate the Social Score. The weighted reviews may be combined to calculate a weighted aggregate review. Other algorithms and numerical weights will occur to the skilled person, which are functionally equivalent to the above examples.

The professional experience data may be obtained from profiles of people on social networks, personal blogs, university faculty listings, company webpages showing employees, job websites, and databases of directors. A social network agent accesses the professional experience data to determine data such as job title, past job titles, industries worked, past companies, employment timelines, and education. From this data the agent determines how relevant the social contact is to the business segment being evaluated. Furthermore the employment timelines and business relationship timelines can be compared to determine whether a social contact was an employee of an organization at the same time as his employer was in a business relationship with the first organization.

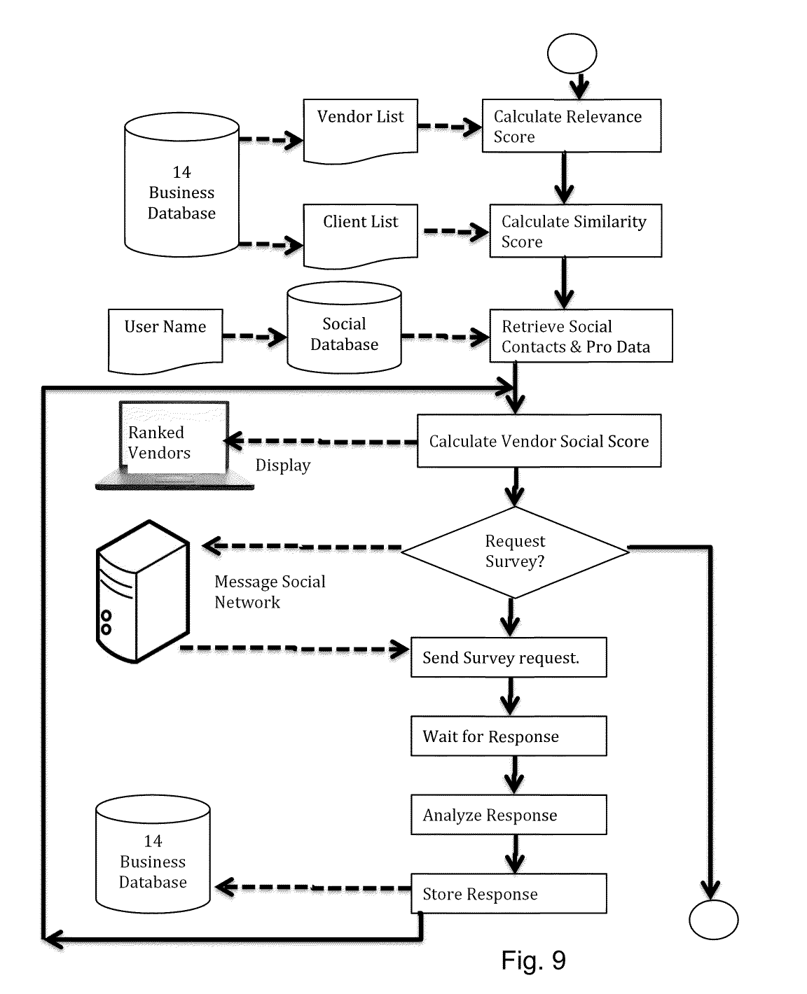

FIG. 9 shows an example workflow for calculating Professional Relevancy Scores. The engine retrieves a set of the user's social contacts and determines which of them are associated with vendors. Then the engine iterates through the associated social contacts, retrieving professional experience data from the social network and extracting keywords and optionally forming clusters of keywords using cluster analysis. The keywords may be matched to a dictionary of typical professional keywords or by using machine learning algorithms such as Term Frequency Inverse Document Frequency (TFIDF) to determine impactful keywords for a particular social contact.

Professional relevance may be determined from a direct match of words in a social contact's professional experience data to words describing an organization or segment thereof or employees thereof. For example the labeled skills of a social contact may match the skills of a vendor's employee or the vendor's profile and attribute data.

Alternatively a set of keywords is retrieved from the business database 14 that are complementary to the business segment being evaluated. The keywords are words to be found in profiles of relevant social contacts, rather than words descriptive of the business segment itself.

The keywords describing the person to referee an organization or business segment thereof may be manually entered by a user such as a representative of the organization itself or by a system administrator on a global basis for all similar business segments.

In one embodiment, the keywords are determined using an supervised learning process that tracks the social relationships and social media activity of social contacts where there are known relationships to build a model of the type of people that can evaluate a given business segment. In a similar way, a social contact's text, hashtags, and labels on micro-blogging websites and forums may be a source of keywords. The engine may reduce the number of social contacts to people who are recorded as referees or a primary contact to organizations for a given business segment.

The engine aggregates terms to find words common to these social contacts, but uncommon in profiles in general. Many words will be meaningless but this Big Data approach will average towards the most useful keywords, including some that might not be intuitive. For example “sudoku” might be found to be a skill common to people who are more highly connected to accountants or Follow accountancy firms. Subsequently finding this skill amongst a social contact's data would suggest that they would be a good referee for an accountancy firm.

In another embodiment, unsupervised learning algorithms such as clustering are performed on business segments of organizations. Clustering may also be performed on the social contact's keywords. Clustering analysis may then be used to compare the sets of clusters from the social contact and the business segment. Rather than count how many keywords match, cluster analysis provides a statistical probability that one cluster or keyword belongs to another cluster, even if only a few of the keywords match.

For example, a product category may have hundreds of keywords which are self-organized into several clusters. A social contact's profile may also be organized into several clusters some of which overlap with the product category. The axes of overlap and the magnitude of each cluster similarity define a vector of matching. The absolute magnitude of the vector may be used as the Professional Relevancy Score.

Similarly, Logical Regression and Pattern Matching techniques may be used to evaluate the extent to which keywords of a social contact are similar to the business segments for which they are a potential referee. The processing of keywords is preferably performed offline and stored in the database 14 for each business segment. Preferably a business segment's definition and keywords are used by a plurality of organizations, rather than being unique to one organization. This reduces the storage requirement and makes keywords more generally applicable.

A large corporation will have many business segments but only a subset evaluated by a user. If the user's social contacts are only clients of a few of the subset, there may appear to be only a few weakly relevant referees. Thus the system may use industries and specialisms being compared in order to capture enough social contacts and optimize relevancy. The effect is to increase the number of keywords that might match those of the social contacts. For example, if the number of social contacts calculated to be relevant to a single specialism is less than a threshold, then the algorithm extends the range to a plurality of related specialisms or to a higher level in a hierarchy of specialisms.

In certain embodiments, the business segment may also be defined by an ideal matching pattern or vector. In other words, the ideal referee is someone with the best balance of matching skills, rather than just a lot of one skill type. Thus a record in the database describing a business segment may comprise sets of keywords for a plurality of clusters and corresponding set of values describing the ideal referee's weighting to these clusters. For example a law firm's specialism of ‘patents’ could be recorded with two sets of words that can be conceptually divided into words describing scientists and words describing entrepreneurs. The corresponding set of values (80, 60) indicates that the ideal referee would be someone whose professional experience data are an 80% match to the scientist cluster and 60% match to the entrepreneur cluster. Therefore someone who is 100% entrepreneur would be ranked as a worse referee for that specialism than someone who is 60% scientist and 50% entrepreneur.

So whilst it would be computationally expensive to compare all vendors across all their specialisms to all of a user's social contacts for all their professional data, the present algorithm need only consider the few keywords of a few social contacts to the few keywords of a subset of business segments for the few associated organizations.

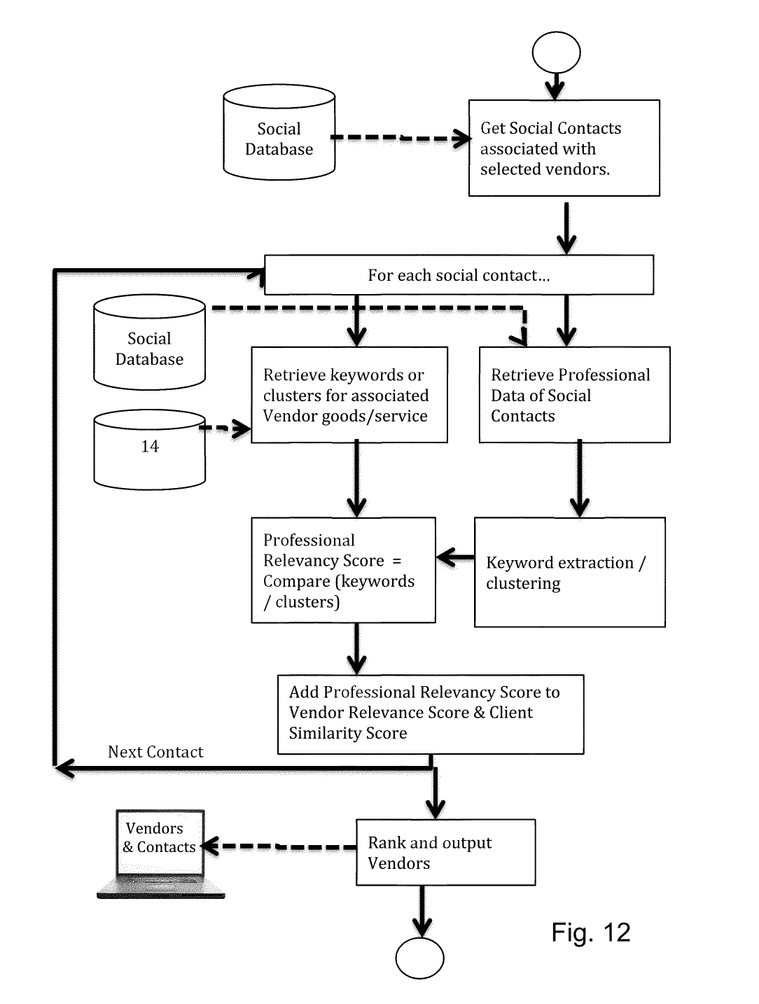

Returning to FIG. 12, the output of the keyword-matching algorithm is a Professional Relevancy Score for the social contact. This score may be further processed using a sigmoid function to ignore scores less than a threshold and limit scores to a maximum value. The Professional Relevancy Score of a social contact is added to the Social Score of the associated first organization. The Professional Relevancy Score is also stored for the social contact. Professional Relevancy Scores are used to weight any surveys from the social contact and/or select social contacts for display to the user.

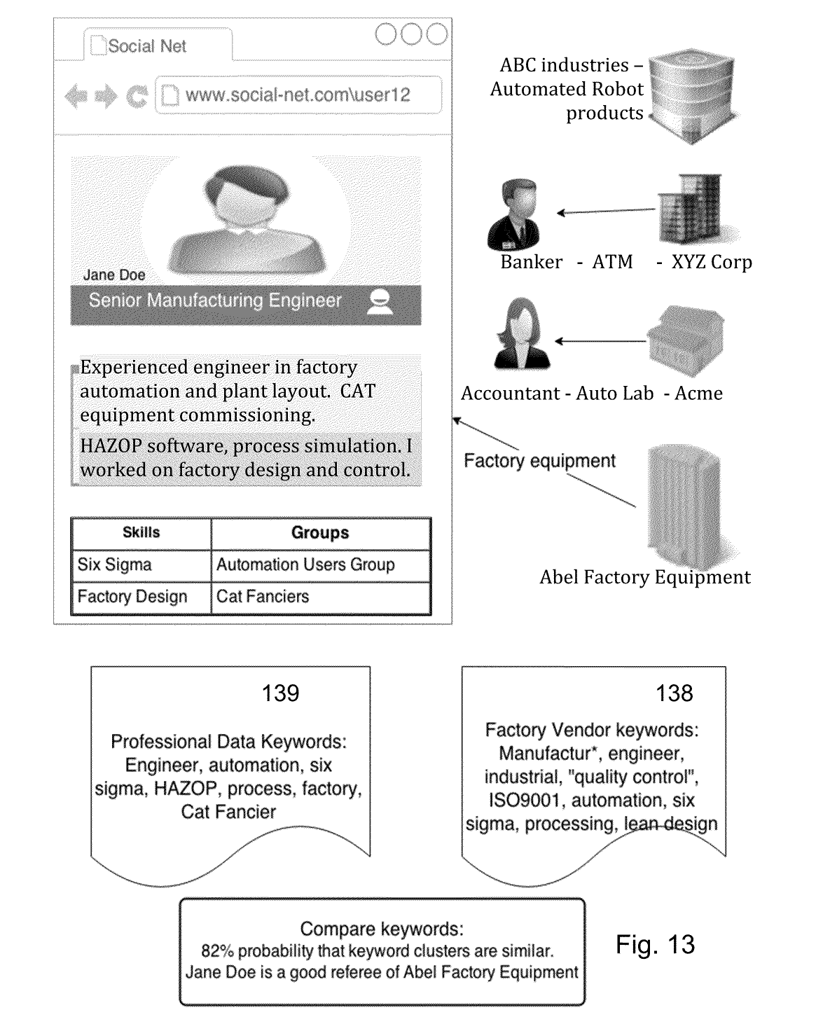

FIG. 13 provides an example of a relevancy computation using the workflow of FIG. 12. A user searches for “automation”, which return four vendors, ABC Industries, XYZ Corp, Acme, Abel Factory Equipment, albeit in different industries or specialisms. Of the user's many contacts, only three have some association with the vendors, a Banker, an accountant, and an Engineer. The professional profile of Jane Doe lists one job title, two experience summaries, two skills and two groups. Seven key terms are identified as Professional Data keywords 139 using feature extraction. The social contact is an employee of a client that purchases factory equipment from Abel Factory Equipment. Abel's product category, “Factory Equipment,” has nine keywords 138, possibly recorded as a cluster. These two sets of keywords are compared to determine that there is a high probability that the keywords belong to the same cluster and so the social contact is deemed to be a good referee of the vendor, Abel Factory Equipment.

By contrast this social contact would not be a good referee of the products categories from the other vendors, notwithstanding the fact that she is not a customer of them anyway. The process is repeated for the other social contacts, which determines that the banker is a moderate referee of XYZ Corp's Automated Teller Machines but the accountant is not a good referee of Acme's Automated Lab Services.

The scoring and ranking of organizations may involve several schemes, some of which may be replaced, some of which may not be calculable because of sparse data, and some of which may be weighted and combined to reach a final Recommendation Score or ranking. FIG. 12 illustrates scoring a vendor after the sets of vendors and clients have been identified.

A first score is the Vendor Relevancy Score, which indicates the relevancy of the organization in terms of the absolute strength of the organization and the match of its attribute data to the search criteria. Thus a firm that earns significant revenue from a specialism highly matching the search criteria will have a higher Vendor Relevancy Score than a firm that earns very little from a less similar specialism. This score does not require any information about the user or business relationships and provides a useful initial ranking in the absence of further information.

The Client Similarity Score (discussed above) is calculated from the similarity between the third organization and second organizations.

A Social Score can be calculated from one or more of: (i) the quantity of social contacts; (ii) professional relevance of the social contact to the business segment, (ii) survey response provided by a user's own social contacts; and (iii) aggregated survey data of all social contacts. Initially the Social Score may be calculated from the quantity of social contacts connected to the user that are also connected directly or indirectly to the first organization. Survey responses or recommendations may be received from some of the social contacts of the user, which refines the Social Score. Previous reviews sent to other users are aggregated to form part of the Social Score. The Social Score will depend on how much social information is available at any time, which will improve over time and throughout the user's experience. For example, the system may initially only know about certain social contacts and have previous survey responses for only certain organizations. As survey responses are received from social contacts over a period of weeks, the Social Score will be refined from personal and aggregated responses. Thus the user will see a different ranking of organizations as time goes on and may be notified of any ranking changes.

One application of identifying and ranking social contacts is to link people to relationship records or to a business segment of the organization. Once the social contacts have been approved by a user, the social contact is recorded as a referee for future evaluation about the linked relationship or business segment. The system identifies a relationship between a first and second organization in the business database and identifies social contacts from a social network that have current or previous work experience with the second organization and thus are potential referees. Preferably the social contacts are scored or ranked for relevancy to the identified relationship or business segment of the first organization, as discussed above.

A user associated with the first or second organization or the social contact himself is contacted using an automated electronic message to confirm the suitability of the social contact to be a referee of the identified relationship or business segment. Preferably the user contacted is an employee of the first organization. More preferably the system identifies whether the contacted user has a social connection recorded on the social network with the social contact being approved.

In a preferred use case, a user employed by a first organization inputs data into the business database about relationships with second organizations. The system identifies and displays to the user profiles of people with current or previous work experience with the second organization. People who are social contacts of the user or other employees of the first organization are highlighted as such or are more highly scored then non-social contacts. The web content comprises means for the user to select people to be referees, in which case the system links the social contact to the relationship or business segment.

In another use case, web content is provided to a user showing organizations to which they are connected via employment, social media and/or business relationships, the web content comprising means for the user to select whether they want to be recorded as a referee for any of these. Preferably the system calculates the Professional Relevancy Scores for the user in relation to each organization and ranks the organizations based on which the user is most relevant for.

As an example, User A working for Vendor A inputs their relationship with Client C for Specialism S. User B indicates Person C at Client C is familiar with the work being done. User C, also working for Client C, sees this new relationship in the database and adds himself as a referee. User D searches the database for Specialism S and finds Vendor A, amongst others. User D is shown that his friends User C and Person B are referees linked to Vendor A, and that his friend Person E also works at Client C. Thus the system provides multiple means to provide social proof of an organization.

To encourage social feedback, the user can request his social contacts to provide a review of certain organizations in which the user is interested. The webpage provides an interactive element for each graphic representing a social contact. The interactive element may be a hyperlink or a mouse hover, or pop-up which is responsive to a user action to provide a survey message or survey web page to the social contact. For example, the message may comprise a pre-populated template asking the social contact to rate the associated organization, provide a review and answer questions specific to the organization's industry. Preferably the message comprises a link to a survey web page hosted by the webserver 10, such that the survey agent can receive survey responses directly from the social contact's interaction with the survey web page. The system is thus able to generate candid reviews due to the personal, private nature of a survey between two connected people. The survey results may be shared publicly in a generalized or aggregated way and without attribution to the reviewer. For example, the system may perform keyword extraction of the review text and average the review star rating with other star ratings to share with other users. This reuses the review without disturbing the candidness of the review (unless the reviewer elects to make it public).

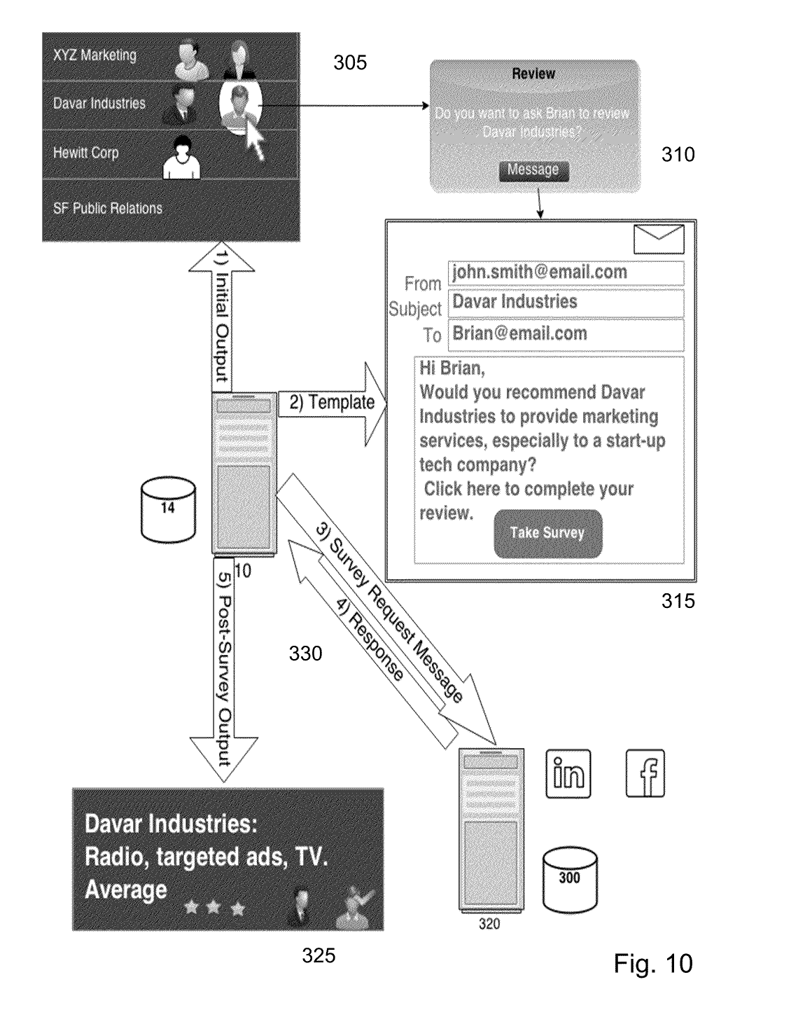

In FIG. 10, a user is shown web content 305 with four vendors and associated referees. Upon clicking an interactive graphic element proximate a vendor, the user is shown a messaging option 310. Further clicking this messaging option, provides the user with an electronic message 315 between themselves and the social contact. The pre-populated message 315 includes the user's name, social contact name and name of organization for review. Preferably the messaging takes place within the server 10 or at least via the server 10. For example, the social contact may be contacted using an internal messaging system of the server 10, using an API to message the social contact at the remote network 320, or by text messaging the social contact through a phone exchange.

**In one embodiment, the system automates the referee selection and survey request process. The survey agent identifies one or more social contacts of the user that are also contacts of employees of first organizations. The agent sends an electronic message to the referees, requesting that they complete a survey about employee(s) of the first organization with whom they are socially connected. This request may be without consulting the user, in order to expedite the process. Neither the user nor vendor employee need know about the survey request, if no response is received. A received response may be shown to the user to qualify the referee's opinion.

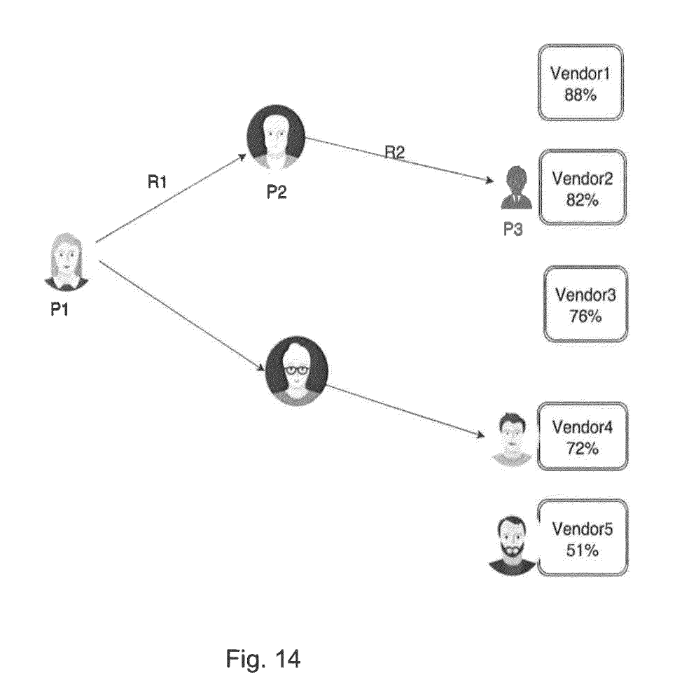

The automatic selection of referees may be made using each social contact's Professional Relevancy Score (as discussed above) and strength of relationships. In FIG. 14, User P1 is connected to social contact P2 by social relationship R1. P2 is connected to Vendor 2 employee P3 by relationship R2. The survey agent may select referees as those: having a Professional Relevancy Score greater than a first threshold; a strength of relationship with the user above a second threshold; and a strength of relationship with the employee above a third threshold. The third threshold may be higher than the second threshold to ensure that the social contact really knows the employee well. The agent may determine Social relationship strength using the frequency of communication there between, similarity of professional data, and endorsements there between. Preferably the referee has recorded an endorsement of the employee in the social graph before.

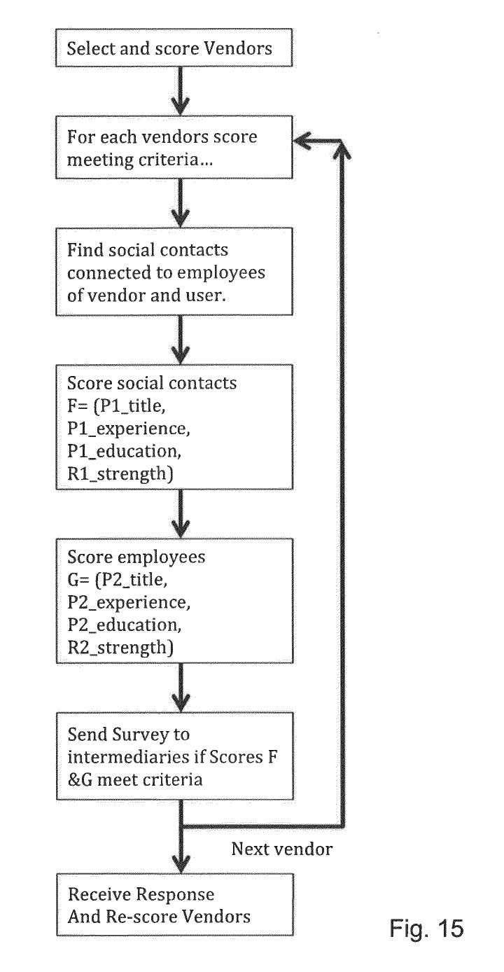

FIG. 15 illustrates how selection of referees may be automated. Employees and social contacts (as potential referees) are scored using their professional attributes and relationship strength, subject to certain criteria, such as exceeding a professional relevancy score threshold or relationship strength threshold. These thresholds may be tuned to ensure that quality responses are received by qualified referees about relevant employees or their employers (i.e. vendors). The system may tune the algorithm such that, on average, about 3 survey responses are received for each search query.

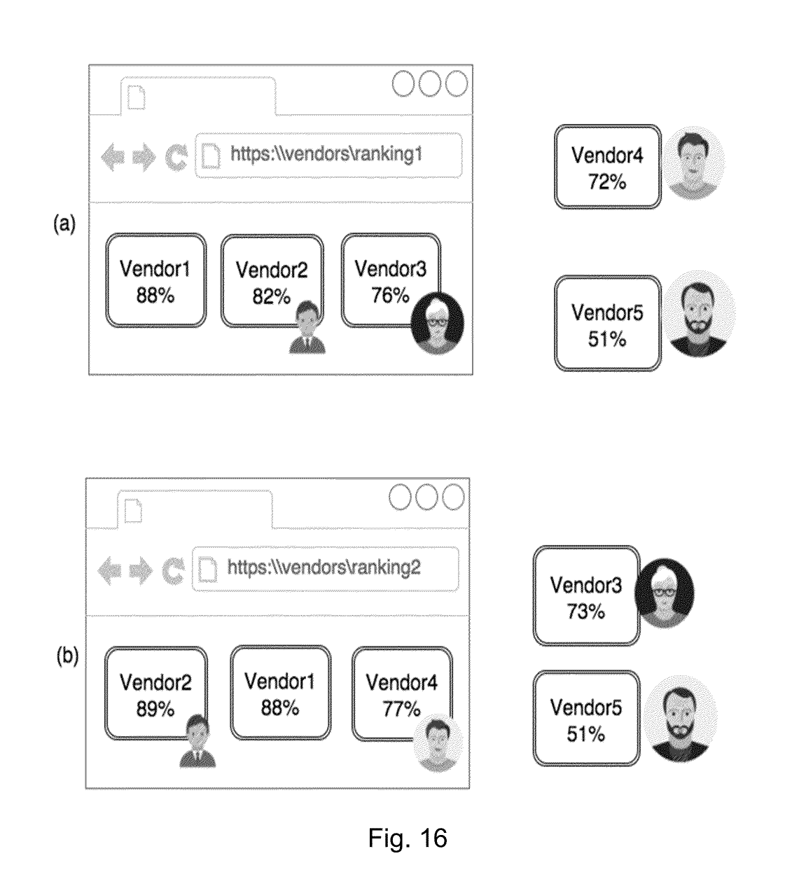

A further consideration in selecting referees is identifying only those vendors whose rank could change as a result of the survey. In FIG. 16 (a), a set of vendors (Vendors 1-5) satisfying the search query are identified and given an initial score (e.g. using vendor relevancy, client similarity and initial social scoring algorithms) as a percentage. Only three vendors are displayable but this number could be set to any limit that is likely to be of interest to the user. The agent determines which vendors rank is able to change sufficiently to be displayed to the user, due to a survey response. The potential change will depend on the weight given to surveys in the overall scoring algorithm. In the example of FIG. 16(a), a survey can change the overall score by ±10% and thus Vendor 4 might change rank sufficiently to be displayed but Vendor5 could not. Thus only social connections regarding Vendors 2, 3 and 4 are selected.

The message 315 is sent via the server 10, on behalf of the user, to a social network or email server 320 for an account of the chosen social contact. At some point, the social contact responds and that response message or response action 330 links back to the server 10 to receive the survey and perform analysis.

Preferably the survey provides the social contact with interactive elements to provide feedback. The survey agent preferably populates the message 315 or survey web content 425 with one or more of: (i) generic review questions; (ii) an overall evaluation of the organization or a relevant business segment; (iii) industry-specific survey content selected from a database of survey content; (iv) and interactive survey elements. The interactive rating elements may be star ratings, radio buttons, drop-down selections, or check boxes. The interactive survey elements enable the social contact to provide a review simply by clicking on the elements, and the feedback can be processed and aggregated with other reviews using consistent terms.

Specific content for the survey is chosen that is most relevant to: the attribute data of the third, first and second organizations involved; the attribute data of the relationship record; and the attribute data of the user and social contact. The system may first consider the first organization (e.g. vendor) attributes, such as industry, specialism, skills, products, etc. to select a set of survey content relevant to evaluate first organizations. From this set, the system may consider the attributes of the second organization (e.g. client's industry) to determine which survey content are relevant to the second organization's experience with the first organization. A third consideration is which questions the social contact is likely to be able to answer. A fourth consideration is which questions are of most relevance to the third organization. These multi-axes considerations are combined to rank and select a set of survey questions or topics to provide to the social contact.

Each survey question or topic may have fields therein that are filled with content related to the organizations or search criteria. For example a generic question can be personalized by completing the blank fields with the name of the vendor, specialism being sought, and industry of the user's organization.

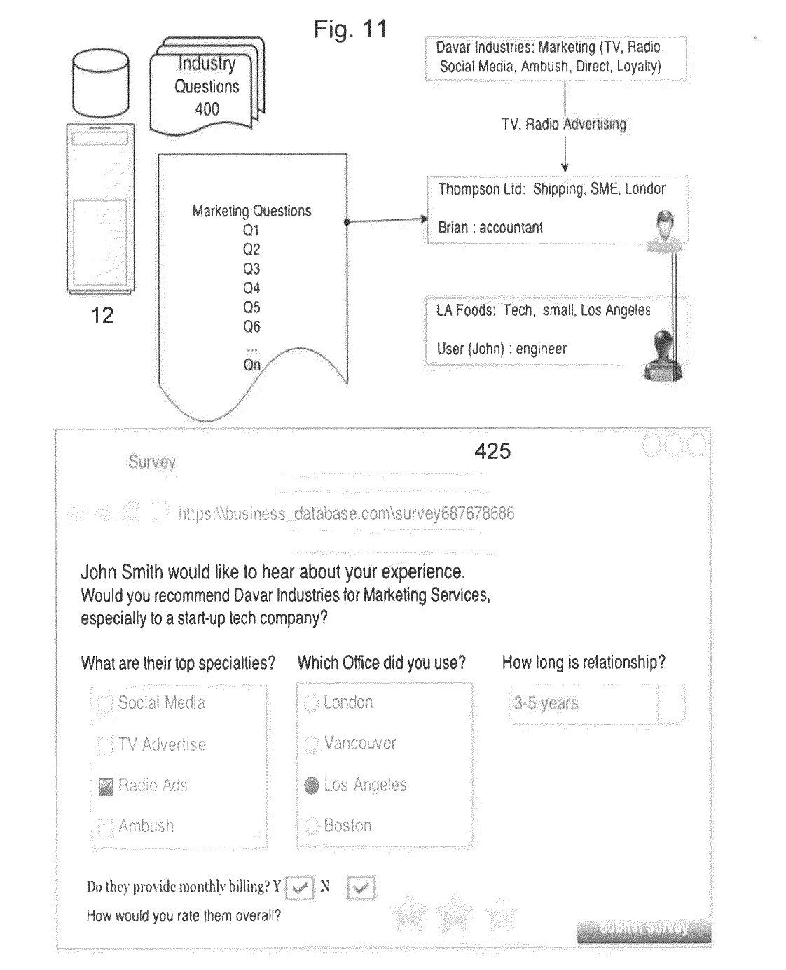

FIG. 11 shows server 12 with access to a database of questions 400 and beside it a simplified graph of business and social relationships. In this example, the vendor's industry is used to select a set of marketing questions, Q1, Q2 . . . . Qn. Attributes of the organizations, people and relationship are used to weight and select five questions, which populate the survey web content 425. A first general recommendation question is chosen and its fields are filled with the vendor name, type of services being sought, and attributes of the user's company. The response to this might be a long text-string. A second survey element is inserted in the form of check boxes where the options are chosen from the specialisms offered by the vendor and the specialisms recorded by the relationship record. A third survey element is a set of radio buttons with relevant locations. A fourth survey element is an accounting question, chosen because the social contact is an accountant. The last survey element is a generic star-rating question.

The survey agent receives the responses asynchronously from the social contacts and informs the user when a survey has been processed. The survey agent determines negative and positive sentiment expressed in the text and assigns this sentiment to the question (if any) that invoked the response. The survey agent also identifies keywords that are written about the vendor, such as specialisms, skills, or products. The social contact's selections from the interactive survey elements are recorded.

The analysis may be stored in the database 14 with the relevant client-vendor relationship record (i.e. the client for whom the social contact works), which is privately viewable by the present user, or viewable in aggregate by subsequent users. The survey agent may calculate the average rating or sentiment (preferably weighted by the Professional Relevancy Score of the social contacts) and store them as aggregated survey data for the organization for public viewing by all users. For example, the survey agent may calculate an organization's overall star rating, average sentiment expressed for certain questions, count of endorsements for certain skills, and compile a list of keywords, as shown in the revamped web content 325 of FIG. 10.

The recommendation engine then updates the social score using the new survey data from the user's social contacts and an updated aggregated survey data from social contacts of all users. The engine combines the Vendor Relevancy, Client Similarity, and Social Scores. The scores may be weighted to produce an overall score and rank to select first organizations to be displayed as web content.

In FIG. 16(b) the ranking of vendors has changed due to survey results: Vendor2 has improved to rank 1; Vendor3 is no longer displayed; and Vendor4 is now displayed. The referees and vendor scores may or may be shown beside the relevant vendor.

In certain embodiments, the set of first organizations to be output comprises different first organization selected using each scoring scheme, instead of just those with the highest combined recommendation score. This prevents any one scoring scheme from dominating the recommendation metric and allows for an output with more variety.

The survey response may also be used by the verification agent to verify whether a business relationship is true or not and assess the strength of the relationship. For example, a negative review from a social contact would confirm a relationship involving his organization, but indicate a lower strength. The verification agent may use natural language processing and/or defined fields to determine the reviewer's sentiment of the relationship, its existence, or strength.

Reference in the above description to databases are not intended to be limiting to a particular structure or number of databases. Databases comprising a social network, social media or business relationships may be implemented as a single database, separate databases, or a plurality of databases distributed across a network. The databases may be referenced separated above for clarity, referring to the type of data contained therein, even though it may be part of another database. One or more of the databases and agents may be managed by a third party in which case the overall system and methods or manipulating data includes these third party databases and agents.

Data may be stored in a database as objects, documents, records, edges, nodes, data element, all of which are intended to be covered by the invention. For simplicity ‘data element’ is used to refer to the smallest divisible data and the terms ‘record’ or ‘data object’ used to refer to a collection of ‘data elements’.

The above description provides example methods and structures to achieve the invention and is not intended to limit the claims below. In most cases the various elements and embodiments may be combined or altered with equivalents to provide a recommendation method and system within the scope of the invention. It is contemplated that any part of any aspect or embodiment discussed in this specification can be implemented or combined with any part of any other aspect or embodiment discussed in this specification. Unless specified otherwise, the use of “OR” between alternatives is to be understood in the inclusive sense, whereby either alternative and both alternatives are contemplated or claimed.

For the sake of convenience, the example embodiments above are described as various interconnected functional agents. This is not necessary, however, and there may be cases where these functional agents are equivalently aggregated into a single logic device, program or operation with unclear boundaries. In any event, the functional agents can be implemented by themselves, or in combination with other pieces of hardware or software.

While particular embodiments have been described in the foregoing, it is to be understood that other embodiments are possible and are intended to be included herein. It will be clear to any person skilled in the art that modifications of and adjustments to the foregoing embodiments, not shown, are possible.

1. A computer-implemented method of displaying web content, the method comprising:
(i) using a computer processor, selecting from a business database recording business relationships between organizations, first organizations that are connected by a business relationship to one or more second organizations;
(ii) using a computer processor, accessing a social network and receiving a set of social contacts of a user;
(iii) for each first organization, associating a set of referees, the referees being social contacts that have an employment connection with at least one of the second organizations connected to that first organization;
(iv) using a computer processor, selecting at least a subset of said first organizations based on their associated referees;
(v) preparing web content comprising the subset of first organizations and their associated referees; and
(v) communicating said web content to the user's computing device.

2. A computer-implemented method of displaying web content, the method comprising:
(ii) using a computer processor, selecting from a business database, first organizations and people associated as referees for the first organizations;
(iii) using a computer processor, accessing a social network and receiving a set of social contacts of a user;
(iv) for each first organization, determine which referees are also social contacts of the user;
(v) selecting at least a subset of said first organizations based on their referees that are social contacts of the user;
(vi) preparing web content comprising the subset of first organizations and their referees that are social contacts of the user; and
(vii) serializing and communicating said web content to the user's computing device.

3. A method according to claim 1, further comprising receiving criteria over a network and querying the business database using the criteria to select said first organizations based on attribute data of said first organizations or of the business relationships;

4. A method according to claim 1, further comprising, using a computer processor, calculating a recommendation metric for each of the first organizations from a social score based on their referees and then selecting at least a subset of said first organizations according to the recommendation metric to output as web content;

5. A method according to claim 4, further comprising retrieving professional experience data from the social network for each referee and calculating the social score using a relevance of said professional experience data to the associated first organization or a business segment thereof.

6. A method according to claim 1, further comprising sending a survey request to a selected referee, preferably wherein the survey request comprises a link to a survey web page comprising interactive survey elements.

7. A method according to claim 1, further comprising responding to a user interaction with the web content to an interactive graphic element corresponding to a selected referee to initiate a survey request to that referee.

8. A method according to claim 1, further comprising retrieving survey content from a database of industry-specific survey content and providing said survey content to a selected referee.

9. A method according to claim 1, further comprising receiving and analysing a survey response from one of the referees and calculating the social score of an associated first organization using the analysis, preferably further comprising storing the analysis in the database.

10. A method according to claim 4, wherein calculating the social score for each first organization comprises aggregating survey responses about that first organization from social contacts of the user and previous survey responses from social contacts of other users.

11. A method according to claim 1, wherein selecting at least a subset of said first organizations comprises calculating a client similarity score based on similarity between the second organizations and a third organization with whom the user has an employment connection.

12. A method according to claim 3, wherein selecting at least a subset of said first organizations comprises calculating a relevancy metric for each of the first organizations based on the relevance of their attribute data to the criteria.

13. A method according to claim 1, wherein selecting at least a subset of said first organizations comprises using each of a plurality of scoring schemes to select at least one organization.

14. A method according to claim 1, wherein said web content further comprises identification data of second organizations that are marked as visible and identification data of second organizations that are marked as hidden if that second organization is an employer of one of the social contacts.

15. A computer system comprising: a database of business relationships between organizations; one or more computer processors; and computer-readable media having instructions for execution by the one or more processors, which instructions when executed provide:
a data access agent for retrieving first organizations and second organizations that are connected by a business relationship;
a social network agent for retrieving a set of social contacts of a user, and associating each first organization with social contacts that have an employment connection with second organizations having a business relationship with that first organization;
an output agent for selecting at least a subset of said first organizations based on their associated referees and preparing web content comprising the subset of first organizations and their associated referees; and
a serialization agent for communicating said web content to the user's computing device.

16. A system according to claim 15, wherein the instructions further provide a recommendation engine for calculating a recommendation metric for each of the first organizations from a social score based on the associated social contacts;

17. A system according to claim 15, wherein the instructions further provide a user-interface for receiving criteria for a recommendation of first organizations from a user;

18. A system according to claim 15, wherein the instructions further provide a survey agent for communicating a survey to a social contact selected by the user.

19. A system according to claim 15, wherein the survey agent is arranged to receive a response to said survey and analyze said response and store the analysis in the database.

20. The method of claim 15, wherein the database comprises organization records, relationship records and records for storing survey response data for an organization.
